(19) United States
(12) Patent Application Publication
(10) Pub. No.: US 2025/0219454 A1
(43) Pub. Date: Jul. 3, 2025

(54) PEER-TO-PEER WIRELESS CHARGING

(71) Applicant: Cisco Technology, Inc., San Jose, CA (US)

(72) Inventors: Vinay Saini, Bangalore (IN); Jerome Henry, Pittsboro, NC (US); Robert Barton, Vancouver (CA)

(21) Appl. No.: 18/981,402

(22) Filed: Dec. 13, 2024

(30) Foreign Application Priority Data
Dec. 27, 2023 (IN) 202341089082

(51) Int. Cl. H02J 50/20; H02J 50/00; H04W 60/06; H04W 72/0446

(52) U.S. Cl. CPC H02J 50/20; H02J 50/001; H04W 60/06; H04W 72/0446

(57) ABSTRACT

Wi-Fi energy harvesting typically relies on access points to transmit energy frames and lacks the capability of direct power sharing between wireless clients. To address this, devices, systems, methods, and processes for facilitating peer-to-peer (P2P) wireless charging are described herein. A client device in a network transmits a charging ability indication and receives, based on the charging ability indication, a charging association request from a peer device. The peer device may transmit the charging association request based on a current power level of the peer device. The client device establishes a charging session with the peer device based on the charging association request, and transmits, based on the established charging session, one or more charging frames to the peer device. The client device may establish the charging session with the peer device with or without an assistance from an AP.

### CROSS-REFERENCE TO RELATED APPLICATIONS

This application claims the benefit of priority to Indian Provisional Application No. 2023/41089082, filed Dec. 27, 2023, the entirety of which is incorporated herein by reference.

The present disclosure relates to communication networks. More particularly, the present disclosure relates to peer-to-peer contactless wireless charging.

### BACKGROUND

In recent years, the demand for energy-efficient technologies has grown significantly, driven by the increasing use of portable electronic devices. These portable electronic devices, such as smartphones, wearables, Internet of Things (IoT) sensors, or the like, often face challenges related to battery life, requiring frequent recharging or dependence on external power sources. Wi-Fi energy harvesting has emerged as a promising solution to address these challenges.

Wi-Fi energy harvesting enables Access Points (APs) to transmit power to client devices through energy frames and directed beams. Thus, allowing compatible Wi-Fi-enabled clients to harness energy from APs, potentially extending battery life and providing an alternative to traditional charging methods. However, Wi-Fi energy harvesting may be limited due to its dependence on AP infrastructure, particularly in environments where Wi-Fi infrastructure is unavailable. For example, in environments such as remote outdoor areas or emergency situations, client devices or other Wi-Fi-capable gadgets may lack access to the necessary AP-based power source, reducing the potential for energy harvesting. While APs facilitate power transmission, the existing Wi-Fi framework does not support direct power exchange between Wi-Fi-enabled devices, thus maintaining an AP-centred approach to power transfer. Such dependence on APs may hinder the flexibility and adaptability of Wi-Fi energy harvesting, especially in mobile or infrastructure-free scenarios where the presence of APs may not be guaranteed.

### SUMMARY OF THE DISCLOSURE

Systems and methods for facilitating peer-to-peer (P2P) contactless wireless charging in accordance with embodiments of the disclosure are described herein.

In many embodiments, a client device comprises a processor and a memory. The memory is coupled to the processor, and comprises a charging management logic that is configured to transmit a charging ability indication. The charging management logic is further configured to receive a charging association request from a peer device based on the charging ability indication, establish a charging session with the peer device based on the charging association request, and transmit, based on the established charging session, one or more charging frames to the peer device.

In a variety of embodiments, the charging management logic is further configured to detect whether a power level of the client device is greater than or equal to a power level threshold value and switch the client device to a charge provider mode based on the power level of the client device being greater than or equal to the power level threshold value. The charging ability indication is transmitted based on the switching to the charge provider mode.

In a number of embodiments, the charging management logic is further configured to allocate a transmission time window to the peer device based on the established charging session. The one or more charging frames are transmitted to the peer device during the transmission time window.

In several embodiments, the one or more charging frames charge the peer device without a physical contact between the peer device and the client device.

In additional embodiments, the one or more charging frames include one-way energy harvesting frames.

In numerous additional embodiments, the one or more charging frames include at least one non-data bearing frame.

In more embodiments, the charging management logic is further configured to detect whether a power level of the client device is less than or equal to a power level threshold value and terminate the charging session based on the detection that the power level is less than or equal to the power level threshold value.

In numerous embodiments, the charging management logic is further configured to transmit, to the peer device, a dissociation message indicating the termination of the charging session.

In various embodiments, the charging management logic is further configured to receive a dissociation message from the peer device, and terminate the charging session based on the received dissociation request.

In one or more embodiments, the charging ability indication is configured to indicate at least one of: a peer-to-peer charge providing capability of the client device, an amount of power the client device is capable of providing, or a channel bandwidth to establish the charging session.

In yet more embodiments, the charging ability indication is transmitted to the peer device.

In still more embodiments, the charging ability indication is configured to indicate a signal strength threshold value. The charging association request is received from the peer device based on a signal strength of the charging ability indication received at the peer device being greater than or equal to the signal strength threshold value.

In still yet more embodiments, the charging ability indication is transmitted to an access point to register the client device in a charging database of the access point.

In many further embodiments, the charging management logic is further configured to detect whether a power level of the client device is less than or equal to a power level threshold value, and transmit, to the access point, a de-registration request to remove the client device from the charging database based on the detection that the power level is less than or equal to the power level threshold value.

In many additional embodiments, the charging session between the client device and the peer device is established with an assistance from the access point.

In several more embodiments, a peer device comprises a processor and a memory communicatively coupled to the processor. The memory comprises charging management logic that is configured to transmit, based on a current power level of the peer device, a charging association request configured to indicate a peer-to-peer charging capability of the peer device. The charging management logic is further configured to establish a charging session with a client device based on the charging association request and receive, from the client device, one or more charging frames based on the established charging session.

In several additional embodiments, the peer device further comprises an energy harvesting circuit that is configured to charge the peer device based on the received one or more charging frames

In numerous additional embodiments, the charging management logic is further configured to receive a charging ability indication from the client device, detect a signal strength of the received charging ability indication, and compare the detected signal strength with a signal strength threshold value. The charging association request is transmitted further based on the detected signal strength being greater than the signal strength threshold value.

In further additional embodiments, the charging management logic is further configured to transmit a dissociation message to the client device based on at least one of a signal strength of the one or more charging frames being less than a signal strength threshold value or the current power level being greater than or equal to a power level threshold value. The charging session terminates based on the dissociation message.

In various additional embodiments, a peer-to-peer wireless charging method comprises transmitting a charging ability indication, receiving a charging association request from a peer device based on the charging ability indication, establishing a charging session with the peer device based on the charging association request, and transmitting, based on the established charging session, one or more charging frames to the peer device.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a conceptual network diagram of various environments that implement a charging management logic in accordance with various embodiments of the disclosure;

FIG. 2 is a schematic block diagram of an example network enabling peer-to-peer (P2P) wireless charging without assistance from access points (APs) in accordance with various embodiments of the disclosure;

FIG. 3 is a schematic diagram illustrating a network enabling P2P wireless charging with AP assistance in accordance with various embodiments of the disclosure;

FIG. 4 is a diagram illustrating a format of a wireless frame utilized for transmitting a charging ability indication in accordance with various embodiments of the disclosure.

FIG. 5 is a flowchart showing a process for P2P wireless charging of a peer device in accordance with various embodiments of the disclosure;

FIG. 6 is a flowchart showing a process for P2P wireless charging of a peer device without AP assistance in accordance with various embodiments of the disclosure;

FIG. 7 is a flowchart showing a process for establishing a P2P wireless charging session in accordance with various embodiments of the disclosure;

FIG. 8 is a flowchart showing a process for initiating a P2P contactless wireless charging session in accordance with various embodiments of the disclosure;

FIG. 9 is a flowchart showing a process for maintaining a charging database of potential charge providers in accordance with various embodiments of the disclosure;

FIG. 10 is a flowchart showing a process for P2P wireless charging in accordance with various embodiments of the disclosure;

FIG. 11 is a flowchart showing a process for establishing a charging session with AP assistance for P2P wireless charging in accordance with various embodiments of the disclosure;

FIG. 12 is a flowchart showing a process for registering/de-registering a client device as a potential P2P wireless charge provider with an AP in accordance with various embodiments of the disclosure; and

FIG. 13 is a conceptual block diagram of a device suitable for configuration with a charging management logic in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein to facilitate peer-to-peer (P2P) contactless wireless charging in a Wi-Fi network with or without assistance from access points (APs). Wi-Fi energy harvesting is an emerging technology that enables APs to deliver power to Wi-Fi-enabled devices by transmitting energy frames (e.g. charging frames) via focused beams. For example, Wi-Fi energy harvesting may allow low power devices (e.g., Ambient power “AMP” devices) to capture small amounts of energy from APs, which can help extend their battery life. However, Wi-Fi energy harvesting may be limited due to its dependence on AP infrastructure. For example, in environments such as remote outdoor areas or emergency situations, wireless client devices or other Wi-Fi-capable gadgets may lack access to the necessary AP-based power source, reducing the potential for energy harvesting. This dependency on APs may restrict the practical application of Wi-Fi energy harvesting.

Currently, there is no standard method for direct wireless power transfer between Wi-Fi enabled clients over Wi-Fi connection. While solutions like reverse wireless charging exist, they rely on close-range, direct-contact methods and do not support power transfer over wireless networks. This lack of a P2P energy-sharing solution over Wi-Fi prevents the formation of ad-hoc energy-sharing networks, hindering wireless client devices from collaboratively redistributing power to extend battery life. Consequently, Wi-Fi client devices remain dependent on APs for power, limiting their flexibility in infrastructure-free environments, such as outdoor or emergency situations, where battery conservation is required. Thus, the present disclosure provides a solution for contactless P2P wireless charging, allowing Wi-Fi clients to harvest energy from peer Wi-Fi clients. A client device in a wireless network may function as a power source, transmitting energy that nearby peer devices can utilize to recharge over Wi-Fi. The client device may be configured with reverse wireless charging capabilities that enable transmission of wireless charging frames to charge (or recharge) nearby peer devices, for example, internet of things (IoT) devices, AMP devices, sensors, wearables, mobile devices, or other wireless devices. The client device may include, for example, a smartphone, a tablet, a laptop, a portable power bank, a smart home hub, or any other Wi-Fi enabled device.

In many embodiments, the client device may include a processor and a memory communicatively coupled to the processor. In some embodiments, the memory may include a charging management logic. In some more embodiments, the charging management logic can be embodied as a standalone component within the client device. The charging management logic may facilitate P2P wireless charging on the client device to charge peer devices in its vicinity in a contactless manner. For example, instead of using a magnetic resonance or inductive charging technology, the charging management logic may enable the client device to leverage radio frequency (RF) energy to wirelessly transfer power to the peer devices. Since RF energy can cover larger distances (e.g., several meters, 3-10 meters or more) compared to inductive or magnetic resonance based charging, which is typically effective only within a very short range of 1-20 centimeters (about 10-100 times smaller), the peer devices may not be required to be in contact or close physical proximity of the client device for recharging.

In a number of embodiments, the client device may be configured to detect whether a power level of the client device is greater than or equal to a first power level threshold value. Based on the power level of the client device being greater than or equal to the first power level threshold value, the client device may switch to a charge provider mode. Upon switching to the charge provider mode, the client device may be configured to transmit a charging ability indication. “Charging ability indication” may refer to an indication that informs peer devices regarding the capability of the client device to transfer power wirelessly. The charging ability indication may be configured to indicate at least one of a P2P charge providing capability of the client device, an amount of power the client device is capable of providing, or a channel bandwidth to establish a charging session. For example, a smartphone with reverse charging capability may transmit a charging ability indication that specifies that the smartphone can provide P2P charging to nearby peer devices. The charging ability indication may include details such as a maximum power level (e.g., 5 watts) the smartphone can provide and a channel bandwidth (e.g., 20 MHz) over which the power may be provided. Thus, the charging ability indication may allow nearby peer devices to assess whether the client device is a suitable power source for recharging. In one or more embodiments, the charging ability indication may be further configured to indicate a signal strength threshold value (e.g., a Received Signal Strength Indicator “RSSI” value or proximity threshold). The “signal strength threshold value” may refer to a minimum signal strength or proximity level required for any peer device to receive power or charge from the client device. The signal strength threshold value or the proximity level may ensure that only those peer devices that are within an optimal distance from the client device, where signal quality is sufficient for power transfer, can connect to the client device for recharging. Thus, by setting a specific RSSI (for example, −60 dBm, −30 dBm, or the like) as the signal strength threshold value or a maximum distance as the proximity level, the client device can control a Quality of Service (QOS) for power transfer. For example, peer devices that fall below the signal strength threshold value or outside the proximity level may be considered out of range for charging and thus be prevented from connecting to the client device.

In more embodiments, the charging ability indication may be transmitted via one or more information elements in a wireless frame. In a non-limiting example, the wireless frame may be a beacon frame. In further examples, the wireless frame may be a probe response frame, an action frame, a broadcast or multicast frame, an association response frame, an advertisement protocol (e.g., Bluetooth low energy “BLE” advertising) frame, or the like.

In yet various embodiments, a peer device may receive the charging ability indication from the client device. Upon receiving the charging ability indication, the peer device may detect a signal strength of the received charging ability indication and compare the detected signal strength with the signal strength threshold value indicated by the charging ability indication. In still more embodiments, the peer device may monitor a current power level of the peer device. If the current power level is less than a second power level threshold value, and the detected signal strength is greater than the signal strength threshold value, the peer device may be configured to transmit a charging association request configured to indicate a P2P charging capability of the peer device. The P2P charging capability may be transmitted on the basis of an energy harvesting circuit equipped in the peer device. The “energy harvesting circuit” may refer to a circuit designed to capture, convert, and store energy from ambient sources such as light, heat, RF signals, or mechanical vibrations. The captured energy may then be utilized to power the peer device, extending their battery life or enabling operation without batteries. In many further embodiments, the energy harvesting circuit can be integrated or externally coupled to the peer device. In various additional embodiments, the peer device may be configured to transmit a charging request (e.g., a probe request) if the current power level is less than the second power level threshold value. In such embodiments, the peer device may receive the charging ability indication from the client device as a probe response to the charging request.

In a variety of embodiments, the client device may be configured to receive the charging association request from the peer device based on the charging ability indication. In other words, if the signal strength of the charging ability indication received at the peer device is greater than or equal to the signal strength threshold value, the client device may receive the charging association request from the peer device. The client device may further establish a charging session (e.g., a direct charging session) with the peer device based on the charging association request and transmit, based on the established charging session, one or more charging frames to the peer device. The “charging frames” may refer to specialized energy packets that can facilitate wireless power transfer between two wireless devices. The charging frames may be RF energy frames that can charge the peer device without cables or physical proximity. In further embodiments, the one or more charging frames may include one-way energy harvesting frames. In still further embodiments, the one or more charging frames may include non-data bearing frames. In additional embodiments, the client device may be configured to allocate a transmission time window to the peer device based on the established charging session and the one or more charging frames may be transmitted to the peer device during the transmission time window. In several embodiments, the peer device may establish the charging session with the client device based on the charging association request and receive, from the client device, the one or more charging frames. The energy harvesting circuit may be configured to charge the peer device based on the received one or more charging frames.

In still several embodiments, the peer device may be configured to transmit a dissociation message to the client device based on at least one of a signal strength of the one or more charging frames being less than the signal strength threshold value or the current power level of the peer device being greater than or equal to a third power level threshold value. The client device may receive the dissociation message from the peer device and terminate the charging session based on the received dissociation message In other words, the charging session may be terminated based on the dissociation message of the peer device.

In still additional embodiments, instead of receiving the dissociation message from the peer device, the client device may transmit a dissociation message to the peer device to indicate termination of the charging session. In such embodiments, the client device may be configured to detect whether a power level of the client device is less than or equal to a fourth power level threshold value. Upon detection that the power level of the client device is less than or equal to the fourth power level threshold value, the client device may be configured to terminate the charging session and transmit to the peer device, the dissociation message indicating the termination of the charging session. The client device may further switch from the charge provider mode to a non-charge provider mode based on the detection that the power level is less than or equal to the fourth power level threshold value. In numerous embodiments as described above, the charging session between the client device and the peer device may be established without an assistance from any AP.

However, in numerous additional embodiments, a charging session between a client device and a peer device can also be established with assistance from an AP communicatively coupled to the client device and the peer device. In such embodiments, the AP may be configured to maintain a charging database that includes a list of potential P2P charge providers. The AP may receive one or more charging ability indications from one or more client devices, and register, the one or more client devices as potential P2P charge providers in the charging database based on the received one or more charging ability indications. The AP may receive a charging request from a peer device that needs charging. Based on the charging request, the AP may poll registered client devices to determine which registered client device is available to charge the peer device. Based on the polling, the AP may receive, from at least one registered client device in the charging database, an acknowledgment to charge the peer device. The AP may then assist the registered client device and the peer device in establishing a charging session between the client device and the peer device. For example, the AP may enable the client device and the peer device to discover each other, for example, by broadcasting their presence. Then, the AP may assist the client device and the peer device in negotiating various security settings and network parameters. Once the client device and the peer device are authenticated and configured, the client device and the peer device may establish the charging session therebetween.

In various additional embodiments, any of the registered client devices can de-register from being a potential P2P charge provider. For example, a registered client device may compare a power level of the registered client device with a power level threshold value configured with the registered client device. If the registered client device detects that the power level of the registered client device is less than or equal to the power level threshold value, the registered client device may transmit a de-registration request to the AP to remove the registered client device from the charging database. In many further embodiments, the AP may receive the de-registration request and remove the registered client device from the charging database.

Thus, the present disclosure enables P2P wireless and contactless charging between wireless devices with and without AP assistance, thus eliminating the dependency on the APs to provide charge. Further, the present disclosure provides flexibility in diverse environments, enabling power transfer in remote, emergency, or AP infrastructure-free areas where traditional charging options are unavailable. Leveraging Wi-Fi for power transfer enables energy sharing between Wi-Fi enabled devices, extending battery life, enhancing autonomy, and supporting sustainable operation of IoT and mobile devices. Additionally, P2P charging sessions reduce dependency on wired connections, promoting a cleaner, more adaptable charging solution that supports efficient, on-the-go power sharing.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.”. Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C #, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit. Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data. Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.”. An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

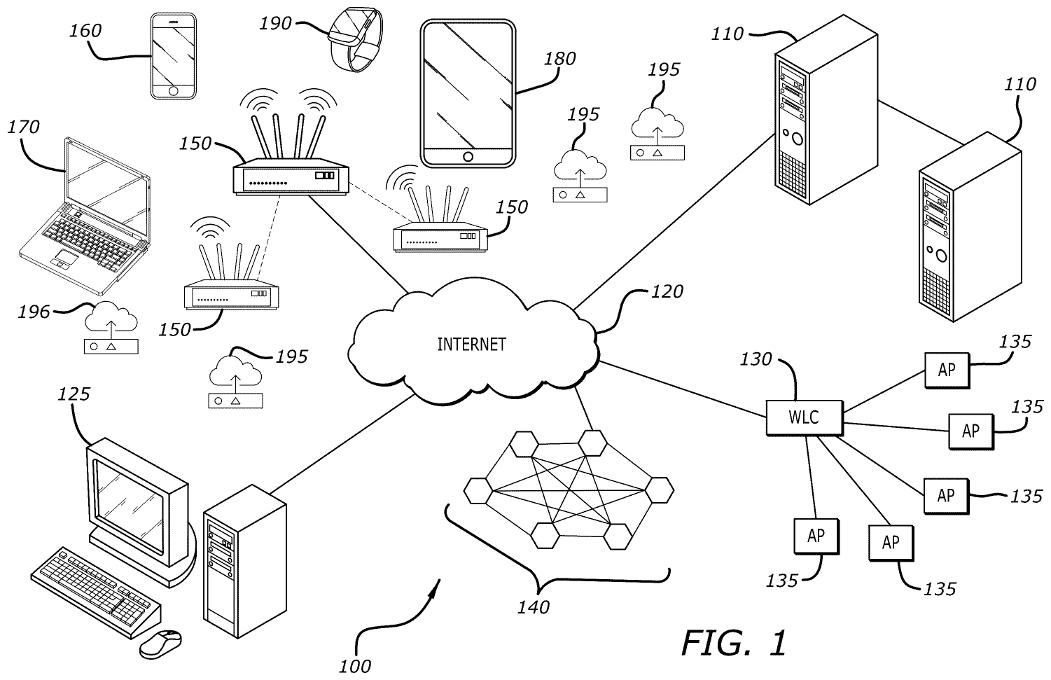

Referring to FIG. 1, a conceptual network diagram of various environments that implement a charging management logic in accordance with various embodiments of the disclosure is shown. The charging management logic can include various hardware and/or software deployments and can be configured in a variety of ways. In some non-limiting examples, the charging management logic can be configured as a standalone device, exist as a logic within a client device, be distributed among various client devices operating in tandem, or remotely operated as part of a cloud-based network management tool. The embodiments shown in FIG. 1 illustrate a network 100 comprising a plurality of client devices that can implement the charging management logic to execute peer-to-peer (P2P) wireless charging with or without access point (AP) assistance.

In many embodiments, the network 100 may include cloud-based centralized management servers 110 connected to a communication network 120 (shown as the Internet). The communication network 120 can include wired networks or wireless networks. The centralized management servers 110 can be configured to execute the charging management logic. In a variety of embodiments, the network 100 may further include remote networks, such as, but not limited to a deployed network 140.

In a number of embodiments, the network 100 may include a plurality of APs 150. The APs 150 may facilitate Wi-Fi connections for various electronic devices, such as but not limited to, mobile computing devices including laptop computers 170, cellular phones 160, portable tablet computers 180, wearable computing devices 190, and ambient power (AMP) devices 195. The AMP devices 195 may refer to those network devices that can harness ambient energy sources (for example, solar, thermal, or Radio Frequency “RF” energy) to power their operations, thereby reducing dependency on traditional power supplies and enhancing sustainability. The AMP devices 195 may include, for example, solar-powered Internet-of-Things (IoT) devices, thermal energy harvesting sensors, RF energy harvesting devices, piezoelectric energy harvesting units, ambient light-powered indoor sensors, small-scale wind energy harvesting devices, or the like. These electronic devices may be configured to execute the charging management logic. However, in further embodiments, the charging management logic may be operated as distributed logic across multiple electronic devices.

In more embodiments, the network 100 may include a wireless Local Area Network (LAN) controller (WLC) 130 configured to monitor APs 135 connected to the WLC 130, either wired or wirelessly. The WLC 130 and/or the APs 135 can be configured to execute the charging management logic to assist the electronic devices in P2P wireless charging. In still more embodiments, a personal computer 125 may be utilized to access and/or manage various aspects of the network 100, either remotely or within the network 100 itself. In the embodiment depicted in FIG. 1, the personal computer 125 may communicate over the communication network 120 and can access the servers 110, the APs 150, or the WLC 130.

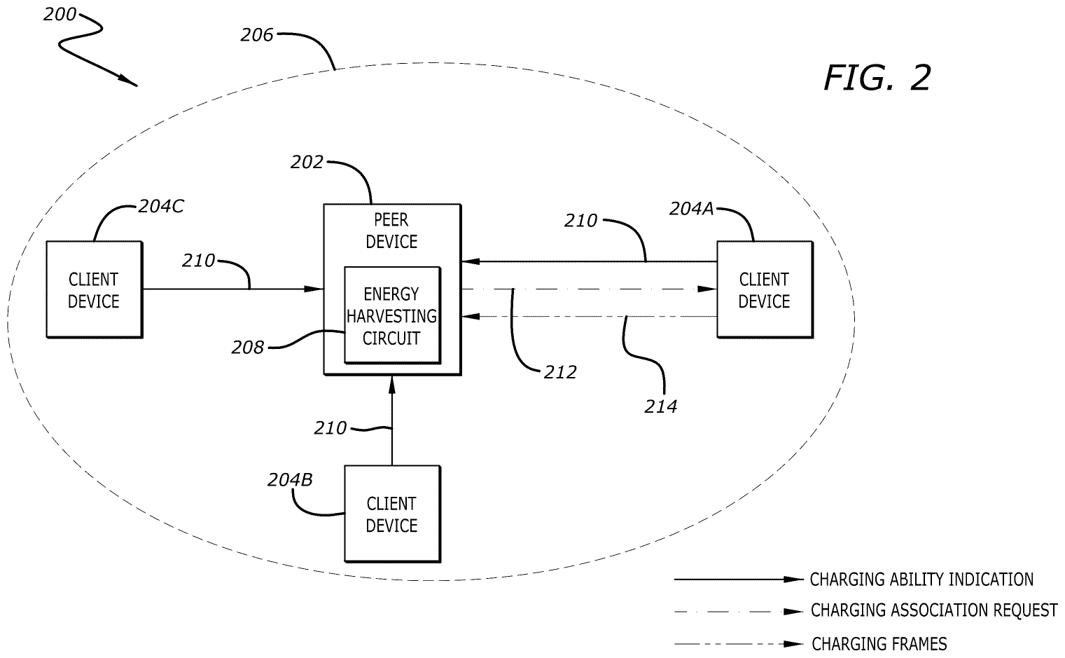

Although a specific embodiment for a conceptual network diagram of various environments that implement a charging management logic suitable for carrying out the various steps, processes, methods, and operations described herein is discussed with respect to FIG. 1, any of a variety of systems and/or processes may be utilized in accordance with embodiments of the disclosure. For example, the charging management logic may be provided as a device or software separate from the electronic devices or the APs 150, 135, the WLC 130, or the like. The elements depicted in FIG. 1 may also be interchangeable with other elements of FIGS. 2-13 as required to realize a particularly desired embodiment.

Referring to FIG. 2, a schematic block diagram of an example network 200 enabling P2P wireless charging without assistance from APs in accordance with various embodiments of the disclosure is shown. The network 200 may correspond to a wireless network facilitating P2P wireless charging. In several embodiments, P2P wireless charging may include utilization of radio frequency (RF) energy to wirelessly transfer charge (e.g., energy or power) from one device to another. Since RF energy can cover larger distances (e.g., several meters, 3-10 meters or more) compared to inductive or magnetic resonance based charging, which is typically effective only within a very short range of 1-20 centimeters (about 10-100 times smaller), a charge receiving device may not be required to be in contact or physical proximity of a charge provider device to implement the P2P wireless charging. In a non-limiting example, the network 200 is shown to include a peer device 202 and one or more client devices, for example, a first client device 204A, a second client device 204B, and a third client device 204C. Hereinafter, the first client device 204A, the second client device 204B, and the third client device 204C may collectively be referred to as “client devices 204A-204C”.

In many embodiments, the peer device 202 may be located within a communication range 206 (for example, RF communication range) of the client devices 204A-204C. Each of the client devices 204A-204C may include reverse charging capabilities, which may enable the client devices 204A-204C to wirelessly charge any peer device present within their communication range 206. Examples of the client devices 204A-204C may include smartphones, laptops, tablets, portable power banks, smart home hubs, or other Wi-Fi-enabled devices with reverse charging or power sharing capabilities.

In various embodiments, the peer device 202 may include an energy harvesting circuit 208. The energy harvesting circuit 208 may include suitable logic, circuitry, and interfaces that are configured to capture, convert, and store energy from ambient sources such as light, heat, RF signals, or mechanical vibrations. This captured energy may be then utilized to power the peer device 202. Though the energy harvesting circuit 208 is shown to be included in the peer device 202, the scope of disclosure may not be limited to it. In some embodiments, the energy harvesting circuit 208 may be externally coupled to the peer device 202 to enable P2P charging. Examples of the peer device 202 may include smartphones, laptops, tablets, portable power banks, smart home hubs, AMP devices, IoT sensors, or the like.

In additional embodiments, each of the client devices 204A-204C may include a processor and a memory communicatively coupled to the processor. The memory may include a charging management logic that is configured to facilitate P2P wireless charging. Alternatively, the charging management logic can be provided as a standalone component within each of the client devices 204A-204C or as an external device that is communicatively coupled to the client devices 204A-204C. Further, the peer device 202 may also include a processor, a memory communicatively coupled to the processor, and a charging management logic. Examples of the processors may include, but are not limited to, Application-Specific Integrated Circuit (ASIC) processors, Complex Instruction Set Computing (CISC) processors, Central Processing Units (CPUs), Explicitly Parallel Instruction Computing (EPIC) processors, Very Long Instruction Word (VLIW) processors, or other processors or circuits. The memories may include suitable logic, circuitry, and interfaces that are configured to store a machine code or the instructions executable by the processors, respectively. The memories may correspond to Random Access Memories (RAMs), Read Only Memories (ROMs), Electrically Erasable Programmable Read-Only Memories (EEPROMs), Hard Disk Drives (HDDs), Solid-State Drives (SSDs), or Secure Digital (SD) cards. In further additional embodiments, the charging management logic may further be implemented in hardware (like Field-Programmable Gate Array “FPGA” or CPUs) or cloud-based solutions.

In further embodiments, the client devices 204A-204C may have various operating modes, for example, a charge provider mode or a non-charge provider mode. In the charge provider mode, a client device may function as a charging source for wireless charging a peer device, while in the non-charge provider mode, the wireless charging capability of the client device may be disabled. Each of the client devices 204A-204C can operate in one of the charge provider mode or the non-charge provider mode based on respective power levels. For example, the first client device 204A may be configured to monitor its power level and detect whether the power level is greater than or equal to a first power level threshold value. In a case where the power level of the first client device 204A is less than the first power level threshold value, the first client device 204A may operate in the non-charge provider mode; however, in a case where the power level of the first client device 204A is greater than or equal to the first power level threshold value, the first client device 204A may operate in the charge provider mode. In other words, based on respective power levels of the client devices 204A-204C being greater than or equal to respective first power level threshold values, the client devices 204A-204C may switch to the charge provider mode. In yet various embodiments, the “first power level threshold value” may refer to a battery or power level below which a client device may not operate as a charge provider. The first power level threshold value can be a configurable parameter or a fixed preset. Further, the first power level threshold value can be a single-level or multi-level threshold. For example, multi-level threshold may be beneficial for reducing frequent mode oscillations. For the sake of ongoing description, it is assumed that the client devices 204A-204C are switched to the charge provider mode.

Each of the client devices 204A-204C may be configured to transmit a charging ability indication 210 based on switching to the charge provider mode. “Charging ability indication” may refer to an indication that informs in-range peer devices regarding a capability of a client device to provide charge or power wirelessly. In still various embodiments, the charging ability indication 210 may be transmitted via one or more information elements in a wireless frame. In a non-limiting example, the wireless frame may be a beacon frame such as an independent Basic Service Set (IBSS) beacon. In more embodiments, the charging ability indication 210 transmitted by each client device 204A-204C may be configured to indicate a P2P charge providing capability of a corresponding client device, an amount of power the corresponding client device is capable of providing, and a channel bandwidth. Further, the charging ability indication 210 transmitted by each client device 204A-204C may be configured to indicate a signal strength threshold value or a proximity level.

The P2P charge providing capability may indicate whether a client device is capable of providing P2P wireless charging. In an example, the wireless frame may include a first information element dedicated to P2P charge providing capability. The first information element can be set to a first value to indicate that the client device is capable of providing P2P wireless charging. However, in the non-charge provider mode, when the client device is incapable of providing P2P wireless charging, the first information element can be set to a second value to indicate that the client device is unable to provide P2P wireless charging. Further, the amount of power may indicate the maximum power output that a client device can provide during P2P wireless charging. In an example, the wireless frame may include a second information element dedicated to indicate the amount of power. The channel bandwidth may indicate a bandwidth that a client device intends to utilize for P2P wireless charging. In an example, the wireless frame may include a third information element dedicated to indicate the channel bandwidth. The signal strength threshold value may indicate a minimum Received Signal Strength Indicator “RSSI” level required from a client device at a receiving peer device to allow P2P wireless charging. In an example, the wireless frame may include a fourth information element dedicated to indicate the signal strength threshold value. The proximity level may indicate a maximum distance from a client device to allow P2P wireless charging. In an example, the wireless frame may include a fifth information element dedicated to indicate the proximity level. Further, one or more of the first through fifth information elements may collectively be referred to as the charging ability indication 210.

In yet more embodiments, the peer device 202, present within the communication range 206, of the client devices 204A-204C may be configured to receive the charging ability indication 210 from each of the client devices 204A-204C. In still more embodiments, upon receiving the charging ability indications 210 from the client devices 204A-204C, the peer device 202 may determine whether the peer device 202 needs charging. For example, to determine whether the peer device 202 needs charging or not, the peer device 202 may monitor a current power level of the peer device 202 and compare the current power level with a second power level threshold value of the peer device 202. The “second power level threshold value” may refer to power level or a power range below which it is safe and efficient to receive power (e.g., energy or charge). The second power level threshold value can be any value less than 100% and greater than 0%. For example, the second power level threshold value can be 80%. Thus, indicating, if the peer device 202 has less than 80% charge remaining, the peer device 202 can be charged. In further examples, the second power level threshold value can be set to 75%, 60%, 50%, or the like. If a result of the comparison indicates that the current power level of the peer device 202 is less than the second power level threshold value, the peer device 202 may need charging. If a result of the comparison indicates that the current power level of the peer device 202 is greater than the second power level threshold value, the peer device 202 may not need charging and the charging ability indications 210 may be discarded. For the sake of brevity, it is assumed that the result of the comparison indicates that the current power level of the peer device 202 is less than the second power level threshold value and the peer device 202 needs charging.

In one or more embodiments, upon receiving the charging ability indications 210 and determining that the peer device 202 needs charging, the peer device 202 may be configured to detect a signal strength of each charging ability indication 210. For example, the peer device 202 may detect an RSSI level of each charging ability indication 210. Further, the peer device 202 may compare the detected signal strength of each charging ability indication 210 with the signal strength threshold value indicated in respective charging ability indication 210. In an example scenario, for the charging ability indication 210 from the first client device 204A, the signal strength threshold value may be −70 dBm, and the peer device 202 may detect the RSSI of −65 dBm. Further, for the charging ability indication 210 from the second client device 204B, the signal strength threshold value may be −72 dBm, and the peer device 202 may detect the RSSI of −75 dBm. Furthermore, for the charging ability indication 210 from the third client device 204C, the signal strength threshold value may be −68 dBm, and the peer device 202 may detect the RSSI of −71 dBm. Based on a result of the comparison, the peer device 202 may be configured to determine which among the client devices 204A-204C exhibited the strongest RSSI relative to respective signal strength threshold value. Continuing the above example, the peer device 202 may determine that the first client device 204A has the strongest RSSI relative to respective signal strength threshold value. As a result, the peer device 202 may select the first client device 204A for receiving charge. In yet many further embodiments, the peer device 202 may be configured to determine a distance of the peer device 202 from each of the client devices 204A-204C. and compare the determined distance with proximity levels indicated in respective charging ability indications 210. Based on a result of the comparison, the peer device 202 may be configured to determine which among the client devices 204A-204C is closest to the peer devices 202 and satisfies the proximity level condition. Continuing the above example, the peer device 202 may determine that the first client device 204A has the strongest RSSI relative to respective signal strength threshold value, satisfies the proximity level condition, or both. As a result, the peer device 202 may select the first client device 204A for receiving charge.

In still yet more embodiments, the peer device 202 may be configured to transmit a charging association request 212 configured to indicate a P2P charging capability of the peer device 202 to the first client device 204A. In other words, based on the current power level of the peer device 202 being less than the second power level threshold value and the detected signal strength of the charging ability indication 210 of the first client device 204A being greater than the signal strength threshold value, the peer device 202 may transmit the charging association request 212 to the first client device 204A. The peer device 202 may exhibit the P2P charging capability based on the energy harvesting circuit 208. In yet additional embodiments, the charging association request 212 may include a unique indicator embedded within a request packet. The indicator may be configured to distinguish the charging association request 212 from standard association requests used in wireless networks for association. For example, the indicator may be implemented as a specific flag, tag, or a field within one or more headers of the charging association request 212.

In a variety of embodiments, the first client device 204A may receive the charging association request 212 from the peer device 202 based on the charging ability indication 210. Upon receiving the charging association request 212 marked with the indicator, the first client device 204A may interpret that the peer device 202 is requesting to establish a connection under a “charging” context. Thus, the first client device 204A, operating in the charge provider mode, may establish a charging session with the peer device 202 based on the charging association request 212. Prior to establishing the charging session, the first client device 204A and the peer device 202 execute one or more authentication and association processes. For example, during authentication, the first client device 204A and the peer device 202 may verify each other's identities. Once authentication is successful, the first client device 204A and the peer device 202 may proceed with the association, where the first client device 204A and the peer device 202 may exchange necessary parameters, such as supported features and capabilities, to establish the charging session via a stable one-way communication link from the first client device 204A to the peer device 202.

Once the charging session is established (e.g., the one-way communication link from the first client device 204A to the peer device 202 is set up), the first client device 204A may transmit, one or more charging frames 214 to the peer device 202. The “charging frames” may refer to specialized energy packets (e.g., RF energy packets) or focused energy signals generated to transfer wireless power or charge from the first client device 204A to the peer device 202. The charging frames 214 may carry the RF energy to charge the peer device 202. The charging frames 214 may enable contactless P2P wireless charging of the peer device 202 by the first client device 204A. In other words, the charging frames 214 may charge the peer device 202 without a physical contact between the peer device 202 and the first client device 204A. In many further embodiments, the charging frames 214 may include one-way energy harvesting frames. In other words, the charging frames 214 may be configured to transmit charge (e.g., energy or power) without requiring any acknowledgement from the peer device 202. In still further embodiments, the charging frames 214 may include at least one non-data bearing frame. In other words, the charging frames 214 may include frames that carry no data payload, specifically generated for the purpose of delivering charge to the peer device 202, ensuring dedicated charge (or power) transfer without the need for data exchange. In yet several embodiments, the first client device 204A may transmit the charging frames 214 in burst to charge the peer device 202. For example, instead of transmitting the charging frames 214 intermittently or sporadically, the first client device 204A may transmit a concentrated stream of RF energy via the charging frames 214 over a short time interval.

In several additional embodiments, the peer device 202 may be configured to transmit a dissociation message to the first client device 204A based on at least one of a signal strength of the charging frames 214 being less than the signal strength threshold value indicated in the charging ability indication 210 of the first client device 204A or the current power level of the peer device 202 being greater than or equal to a third power level threshold value. In other words, once sufficiently charged (for example, charged to 100% or charged to a configurable power level indicated by the third power level threshold value), the peer device 202 may transmit the dissociation message to the first client device 204A. Further, if any of the first client device 204A or the peer device 202 is moving, signal strength of the charging frames 214 received at the peer device 202 may fluctuate. In a case where the signal strength of the charging frames 214 falls below the respective signal strength threshold value or the distance between the peer device 202 and the first client device 204A exceeds the respective proximity level, the peer device 202 may transmit the dissociation message to the first client device 204A for terminating the charging session. In a scenario where the signal strength of the charging frames 214 falls below the respective signal strength threshold value and the peer device 202 still needs more charge, the peer device 202 may establish a new charging session with another client device, for example, the second client device 204B.

In still yet additional embodiments, instead of receiving the dissociation message from the peer device 202, the first client device 204A may transmit a dissociation message to the peer device 202 to indicate a termination of the charging session. For example, the first client device 204A may be configured to detect whether a power level of the first client device 204A is less than or equal to a fourth power level threshold value. Upon detection that the power level of the first client device 204A is less than or equal to the fourth power level threshold value, the first client device 204A may be configured to terminate the charging session and transmit to the peer device 202, the dissociation message indicating the termination of the charging session. The first client device 204A may further switch from the charge provider mode to the non-charge provider mode based on the detection that the power level is less than or equal to the fourth power level threshold value. In numerous embodiments, prior to transmitting the charging frames 214, the first client device 204A may be further configured to allocate a transmission time window to the peer device 202 based on the established charging session. The charging frames 214 may be transmitted to the peer device 202 during the transmission time window. In many further examples, the first client device 204A may terminate the charging session and transmit to the peer device 202, the dissociation message upon lapse of the transmission time window.

Although in FIG. 2 the example network 200 illustrates only one peer device 202 and three client devices 204A-204C, the scope of the disclosure is not limited to it. In an actual implementation, the network 200 can include any number of peer devices and any number of client devices. Further, a client device can simultaneously charge multiple peer devices. For example, if client device is a multi-link radio client, it can connect to multiple peer devices for charging. Further, in numerous additional embodiments, if a client device includes an energy harvesting circuit, even the client device can function as a charge receiving device.

In several more embodiments, the energy harvesting circuit 208 may include one or more antennae configured to capture energy from the charging frames 214. The energy harvesting circuit 208 may further include a matching network and a rectifier. The matching network may adjust an impedance to maximize power transfer between the one or more antenna and the rectifier. The rectifier may convert the RF energy captured from the charging frames 214 to direct current (DC) power. The energy harvesting circuit 208 may further include energy storage components such as capacitors, batteries, supercapacitors, or the like to store the harvested energy.

In yet many embodiments, various thresholds (for example, the first through fourth power level threshold values, the signal strength threshold) described in the foregoing description can be implemented using single-level thresholds. In still yet additional embodiments, the thresholds (for example, the first through fourth threshold values, the signal strength threshold) may be implemented using multi-level hysteresis thresholds. The use of multi-level hysteresis thresholds may prevent frequent mode or state oscillations. For example, if the power level threshold value is implemented as a single-level threshold, even small fluctuations in power level of a client device can repeatedly trigger mode switching between the charge provider mode and the non-charge provider mode.

Although a specific embodiment of a wireless network enabling P2P wireless charging without assistance from APs suitable for carrying out the various steps, processes, methods, and operations described herein is discussed with respect to FIG. 2, any of a variety of systems and/or processes may be utilized in accordance with embodiments of the disclosure. For example, the wireless frame including the charging ability indication 210 may be a probe response frame, an action frame, a broadcast or multicast frame, an association response frame, an advertisement protocol (e.g., Bluetooth low energy “BLE” advertising) frame, or the like. In such embodiments, in addition to adopting an unsolicited approach where the client devices 204A-204C advertise their P2P wireless charging capabilities in beacon frames, the client devices 204A-204C may adopt a solicited approach to indicate their P2P wireless charging capabilities. For example, the peer device 202, upon detecting a charging need, may transmit a charging request (such as a probe request), advertising its charging need and P2P wireless charging capability. Any of the client devices 204A-204C that receive the charging request may transmit a probe response (or a similar message) to the peer device 202. The charging ability indication may be included in one or more information elements of the probe response. The peer device 202 may evaluate the RSSI of such probe responses and select a client device that exhibits the strongest RSSI relative to respective signal strength threshold value and accordingly transmit a charging association request. The elements depicted in FIG. 2 may also be interchangeable with other elements of FIG. 1 and FIGS. 3-12 as required to realize a particularly desired embodiment.

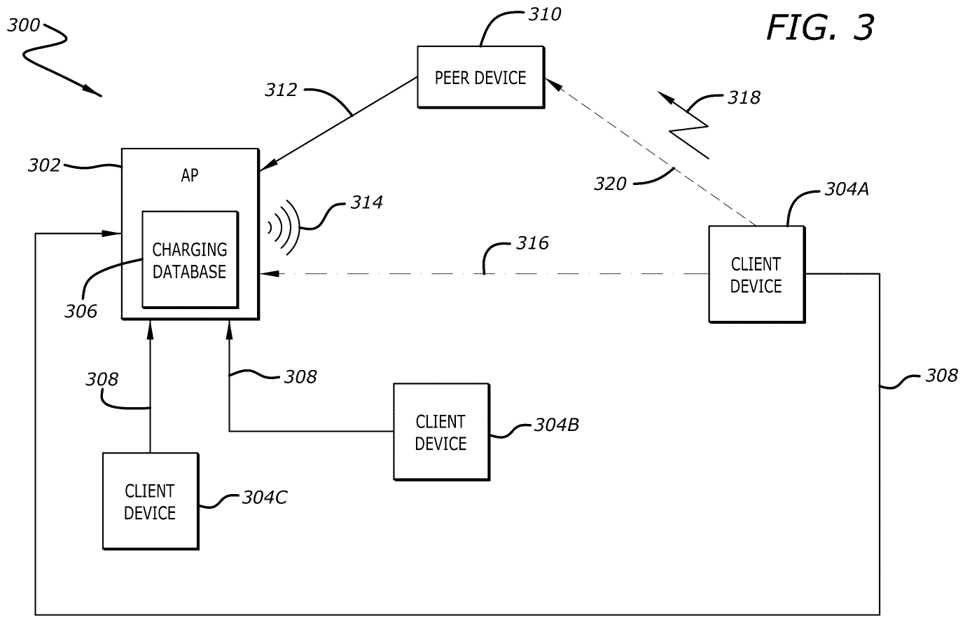

Referring to FIG. 3, a schematic diagram of an example network 300 enabling P2P wireless charging with AP assistance in accordance with various embodiments of the disclosure is shown. The network 300 may correspond to a wireless network facilitating P2P wireless charging with AP assistance. In several embodiments, P2P wireless charging may leverage RF energy to wirelessly charge peer devices equipped with energy harvesting circuit. In a non-limiting example, the network 300 is shown to include an AP 302 which is communicatively coupled to a plurality of client devices, for example, a first client device 304A, a second client device 304B, and a third client device 304C. Hereinafter, the first client device 304A, the second client device 304B, and the third client device 304C may collectively be referred to as “client devices 304A-304C”. Each of the client devices 304A-304C may include reverse charging capabilities, which may enable the client devices 304A-304C to wirelessly charge any peer device present within their communication range. Examples of the client devices 304A-304C may include smartphones, laptops, tablets, portable power banks, smart home hubs, or other Wi-Fi-enabled devices with reverse charging or power sharing capabilities.

In various embodiments, the AP 302 may be configured to assist in P2P wireless charging of a peer device (e.g., low power Wi-Fi devices, IoT devices, sensors, IoT gadgets, AMP devices, or the like) by any of the client devices 304A-304C associated with the AP 302. The AP 302 may include any network device, for example, a Wi-Fi router, an enterprise AP, a mesh network node, a public hotspot, an outdoor Wi-Fi AP, or the like. The client devices 304A-304C may include electronic devices (e.g., laptops, smartphones, smart home hubs, servers, tablets, or other Wi-Fi-enabled devices) with reverse charging capabilities and can provide power or charge to peer devices wirelessly in a contactless manner.

In many embodiments, the AP 302 may be configured to maintain a charging database 306 to assist the client devices 304A-304C in P2P wireless charging. “Charging database” may refer to an organized collection of structured information or data about the client devices 304A-304C or other client devices that are capable of P2P wireless charging. The charging database 306 may include various details such as device identifiers (ID), charging capacity, and connection status of those client devices that have registered with the AP 302 as potential P2P charge providers.

In a number of embodiments, the AP 302 may be configured to receive charging ability indications from client devices that intend to register as potential P2P charge providers. For example, as shown in FIG. 3, the AP 302 may receive charging ability indications 308 from the client devices 304A-304C. “Charging ability indication” may refer to an indication that informs an associated AP regarding a capability of a client device to support P2P wireless charging as a charge provider. In various embodiments, each charging ability indication 308 may be received via one or more information elements in a wireless frame. In a non-limiting example, the wireless frame may be a beacon frame, a probe response frame, an action frame, a broadcast or multicast frame, an association response frame, an advertisement protocol frame, or the like. In yet various embodiments, the charging ability indications 308 may be configured to indicate a P2P charge providing capability of a corresponding client device, an amount of power the corresponding client device is capable of providing, a channel bandwidth, a signal strength threshold value, or a proximity level. The AP 302 may be further configured to register, based on the received charging ability indications 308, the client devices 304A-304C as potential P2P charge providers in the charging database 306. In other words, the AP 302 may update a list of the potential P2P charge providers in the charging database 306 to include the client devices 304A-304C.

In a variety of embodiments, the network 300 may further include a peer device 310 communicatively coupled to the AP 302. The peer device 310, when in need of charging, may transmit a charging request 312 to the AP 302. For example, the peer device 310 may monitor a current power level and compare the current power level with a power level threshold value. If a result of the comparison indicates that the current power level of the peer device 310 is less than the power level threshold value, the peer device 310 may need charging. However, if the result of the comparison indicates that the current power level of the peer device 310 is greater than the power level threshold value, the peer device 310 may not need charging.

In yet various embodiments, the AP 302 may be configured to receive the charging request 312 from the peer device 310. Based on the charging request 312, the AP 302 may poll (shown by indication 314) the registered client devices 304A-304C to determine which client device is currently available to serve the charging request 312 and wirelessly charge the peer device 310. In other words, the AP 302 may transmit probe requests to the registered client devices 304A-304C, upon receiving the charging request 312, to determine which registered client device can charge the peer device 310. For example, the AP 302 may transmit probe requests to client devices connected to the same Basic Service Set (BSS) or associated client devices, verifying which of the registered client devices can charge the peer device 310. In further examples, the AP 302 may transmit one or more management beacons, including the charging request 312, to registered client devices connected to the same BSS to verify which of the registered client devices can charge the peer device 310.

In numerous embodiments, at least one client device (e.g., the first client device 304A) may have a power level greater than or equal to a power level threshold value or may be operating in a charge provider mode. Accordingly, the first client device 304A may transmit an acknowledgment 316 to the AP 302 to charge the peer device 310. The acknowledgment 316 may indicate an acceptance of the probe request by the first client device 304A to charge the peer device 310. Accordingly, the AP 302 may receive, from the first client device 304A the acknowledgment 316. Upon receiving the acknowledgement, the AP 302 may assist the first client device 304A and the peer device 310 in establishing a charging session 318 between the first client device 304A and the peer device 310. For example, the AP 302 may enable the first client device 304A and the peer device 310 to discover each other, for example, by broadcasting their presence. Then, the AP 302 may assist the first client device 304A and the peer device 310 in negotiating various security settings and network parameters. Once the first client device 304A and the peer device 310 are authenticated and configured, the first client device 304A and the peer device 310 may establish the charging session 318 therebetween. Upon establishing the charging session 318, the first client device 304A may transmit one or more charging frames 320 to the peer device 310 to wirelessly charge the peer device 310. The first client device 304A may be configured to transmit the charging frames 320 to the peer device 310 during a transmission time window, after which the first client device 304A may terminate the charging session 318.

In additional embodiments, any of the registered client devices 304A-304C can de-register from being a potential P2P charge provider. For example, after terminating the charging session 318, the first client device 304A may compare its current power level with a preset power level threshold value. If the first client device 304A detects that the power level is less than or equal to the preset power level threshold value, the first client device 304A may transmit a de-registration request to the AP 302 to remove the first client device 304A from the charging database 306. In further embodiments, the AP 302 may receive the de-registration request and remove the first client device 304A from the charging database 306. Once de-registered, a client device may be removed from the list of potential P2P charge providers.

In several embodiments, in response to polling, the AP 302 may receive acknowledgments from more than one registered client devices. In such embodiments, the AP 302 may provide a list of the registered client devices that have accepted to charge the peer device 310. The peer device 310 may then initiate a directed message (e.g., a charging request) to each registered client device from the received list as part of a pre-charging discovery process. Subsequently, each registered client device may transmit one or more sample charging frames to the peer device 310 as a pre-charging response to the charging request. The peer device 310 may then evaluate received sample pre-charging frames to select the most suitable registered client device for P2P charging. In numerous embodiments, the pre-charging discovery can be performed periodically or whenever the signal strength from a connected client device falls below a signal strength threshold value.

Although a specific embodiment for a network enabling P2P wireless charging with AP assistance suitable for carrying out the various steps, processes, methods, and operations described herein is discussed with respect to FIG. 3, any of a variety of systems and/or processes may be utilized in accordance with embodiments of the disclosure. For example, the charging session 318 can also be terminated when a power level of the first client device 304A falls below or becomes equal to a power level threshold value. In other words, if the power level of the first client device 304A is less than or equal to the power level threshold value, the first client device 304A may no longer be able to charge the peer device 310. Accordingly, the first client device 304A may terminate the charging session 318 and transmit a dissociation message to the peer device 310. The elements depicted in FIG. 3 may also be interchangeable with other elements of FIGS. 1-2 and 4-13 as required to realize a particularly desired embodiment.

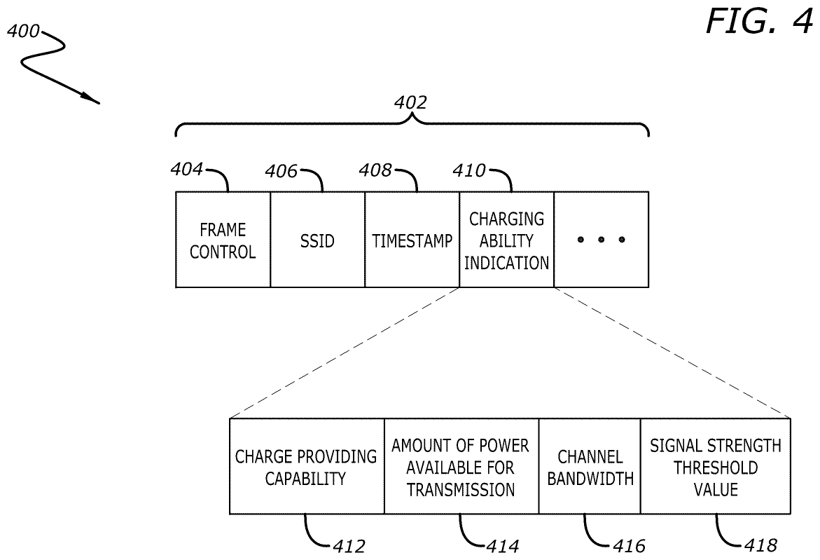

Referring to FIG. 4, a diagram 400 illustrates a format of a wireless frame utilized for transmitting a charging ability indication in accordance with various embodiments of the disclosure is shown. In one or more embodiments, a client device (for example, a smartphone, a computing device, a tablet, or any other wireless enabled device capable of P2P charge sharing) may be configured to transmit one or more charging frames to a peer device to wirelessly charge the peer device. In a variety of embodiments, prior to associating with the peer device for charging, the client device may transmit a wireless frame 402 to announce P2P wireless charging capability. The wireless frame 402 may refer to a wireless packet that advertises an ability of the client device to act as a potential P2P wireless charge provider. Examples of the wireless frame 402 may include, but are not limited to, a beacon frame, a probe response frame, an action frame, a broadcast or multicast frame, an association response frame, an advertisement frame (such as a Bluetooth low energy “BLE” advertisement), or the like. In a variety of embodiments, the wireless frame 402 may include various fields or sub-fields, for example, a frame control field 404, a Service Set Identifier (SSID) field 406, a timestamp field 408, a charging ability indication field 410, or the like.

In more embodiments, the frame control field 404 may define a frame type and associated settings, identifying the wireless frame 402 as a charging ability indication. Further, the frame control field 404 may include a designated value to indicate the frame type. For example, the frame control field 404 may be set to a value “0x0F”, uniquely reserved for charging ability indication type frames. The frame control field 404 having the value “0x0F” may signify that the wireless frame 402 includes specific information, such as a device's P2P charging capability or other related attributes. In yet more embodiments, the SSID field 406 may include a unique network or device identifier, enabling peer devices to recognize the source transmitting the wireless frame 402. For example, a peer device upon receiving the wireless frame 402 may identify the client device signaling availability for P2P wireless charging. This network or device identifier may allow the peer device to differentiate multiple P2P charge providers within communication range. In still more embodiments, the timestamp field 408 may record a precise time the wireless frame 402 is transmitted, aiding in synchronization and ensuring accurate timing for charging coordination. In still yet more embodiments, the charging ability indication field 410 may include one or more information elements such as a charge providing capability 412, an amount of power available for transmission 414, a channel bandwidth 416, and a signal strength threshold value 418.

In additional embodiments, the charge providing capability 412 may indicate whether the client device can perform P2P charging or not. In other words, the charge providing capability 412 may indicate a readiness and capability of Wi-Fi enabled device to wirelessly charge other Wi-Fi enabled devices. In a non-limiting example, the charge providing capability 412 may be a Boolean sub-field. The charge providing capability 412, if set to a first value such as “1”, “True”, “ON”, etc., may indicate that the client device can perform P2P wireless charging. However, the charge providing capability 412, if set to a second value such as “0”, “False”, “OFF”, etc., may indicate that the client device cannot perform P2P wireless charging. It will be understood by a person of skill in the art that the interpretation of “True” and “False” for the charge providing capability 412 may vary based on implementation. In many aspects, “True” may indicate that the P2P wireless charging feature is unavailable, while “False” may indicate that the P2P wireless charging feature is available.

In yet additional embodiments, the amount of power available for transmission 414 may refer to the amount of power the client device can provide to charge the peer device. The amount of power available for transmission 414 may further specify a maximum power output (e.g., in watts or milliwatts) that the client device can provide to charge the peer device. The amount of power available for transmission 414 can vary from one client device to another client device based on device attributes, such as a current power level of the client device.

In still additional embodiments, the channel bandwidth 416 may refer to a range of RF frequencies (e.g., 20 Megahertz “MHz”, 40 MHz) allocated for establishing a P2P charging session between the client device and the peer device. The channel bandwidth 416 may impact the power transfer rate. For example, a wider channel bandwidth (e.g., 40 MHz) may enable fast charging as compared to a narrower channel bandwidth (e.g., 20 MHz).

In still yet additional embodiments, the signal strength threshold value 418 may refer to a minimum signal strength required for initiating a charging session, ensuring that only peer devices within a preset range can be charged wirelessly. In an example, the signal strength threshold value 418 may include an RSSI value or a proximity threshold. By setting a specific RSSI level (for example, −60 dBm) or the proximity threshold (e.g., 10 meters, 20 meters, 40 meters, etc.) as the signal strength threshold value 418, the client device can prevent peer devices that are either too far or too weakly connected to the client device from engaging in P2P wireless charging with the client device. Thus, the signal strength threshold value 418 may allow a peer device to determine if the peer device can rely on the client device as a suitable power source and connect accordingly for efficient power transfer.

Although a specific embodiment for a format of a wireless frame utilized for transmitting a charging ability indication suitable for carrying out the various steps, processes, methods, and operations described herein is discussed with respect to FIG. 4, any of a variety of systems and/or processes may be utilized in accordance with embodiments of the disclosure. For example, the wireless frame 402 can be transmitted either unsolicited or solicited. In some embodiments, the client device may automatically transmit (broadcast, multicast, or unicast) the wireless frame 402 without any explicit request or prompt from a peer device or an associated AP. In some more embodiments, the client device may transmit (broadcast, multicast, or unicast) the wireless frame 402 based on an explicit request or prompt from a peer device or an associated AP. The elements depicted in FIG. 4 may also be interchangeable with other elements of FIGS. 1-3 and 5-13 as required to realize a particularly desired embodiment.

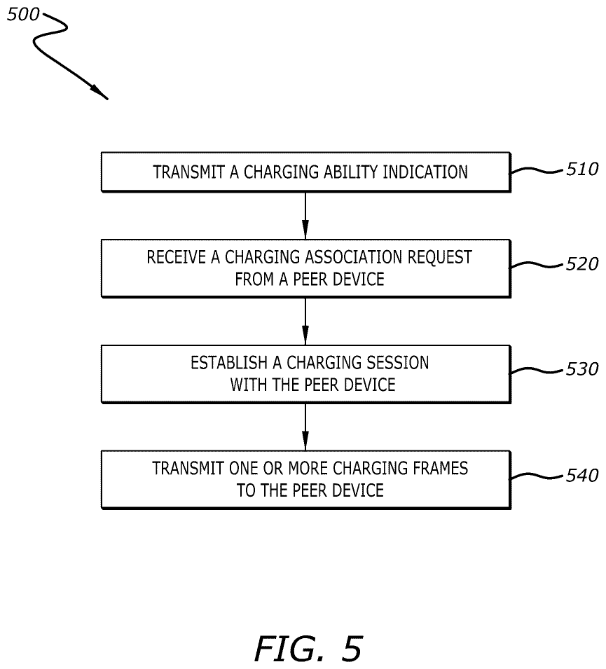

Referring to FIG. 5, a flowchart showing a process 500 for P2P wireless charging of a peer device in accordance with various embodiments of the disclosure is shown. Having disclosed a brief introductory description of example systems and networks within FIGS. 1-4, FIG. 5 depicts the process 500 that enables P2P wireless charging of a peer device (e.g., IoT devices, AMP devices, sensors, wearables, or other wireless devices) by a client device with or without an assistance from an AP. The peer device may be located within communication ranges of one or more client devices (e.g., smartphones, tablets, smart hubs, servers, or the like) that may be configured with P2P wireless charging capabilities. The process 500 may be performed at one such client device that may be configured with charging over Wi-Fi.

In a number of embodiments, the process 500 may transmit a charging ability indication (block 510). The charging ability indication may be configured to indicate at least one of a P2P charge providing capability of the client device, an amount of power the client device is capable of providing, a channel bandwidth to establish a charging session, or a signal strength threshold value. For example, the charging ability indication may specify that the client device can provide P2P charging to nearby peer devices and include details such as the maximum power level (e.g., 5 watts) the client device can supply, the channel bandwidth (e.g., 20 MHz) available to establish a stable charging session, and an RSSI or proximity threshold value to ensure that only peer devices within an optimal distance, where signal quality is sufficient for efficient power transfer, can connect to the client device for charging. In more embodiments, the charging ability indication may be provided in one or more information elements included in a wireless frame, such as a beacon frame, a probe response frame, an action frame, a broadcast or multicast frame, an association response frame, an advertisement frame, or the like. In yet more embodiments, the charging ability indication can be transmitted to an associated AP for registering as a P2P charge provider or directly to peer devices within communication range of the client device.

In a variety of embodiments, the process 500 may receive a charging association request from a peer device (block 520). In many embodiments, the charging association request may be received from the peer device based on the charging ability indication. For example, when the charging ability indication is transmitted to the peer device, the process 500 may receive the charging association request from the peer device. The charging association request may be received from the peer device based on a signal strength of the charging ability indication received at the peer device being greater than or equal to the signal strength threshold value indicated in the charging ability indication. In further embodiments, the charging association request may be received from the peer device based on the charging ability indication and assistance from the associated AP.

In several embodiments, the process 500 may establish a charging session with the peer device (block 530). The process 500 may establish the charging session with the peer device based on the charging association request. The charging session may be a one-way communication session from the client device to the peer device. In several embodiments, the process 500 may establish the charging session for a specific transmission time window. In various embodiments, the charging session may be managed by protocols that regulate factors such as power levels, connection stability, device compatibility or the like, to ensure efficient power transfer.

In numerous embodiments, the process 500 may transmit one or more charging frames to the peer device (block 540). Upon establishing the charging session between the client device and the peer device, the process 500 may transmit the one or more charging frames to charge the peer device. The one or more charging frames may be specialized energy packets designed to facilitate wireless power transfer from the client device to the peer device. The one or more charging frames may carry the energy for charging the peer device. For example, the one or more charging frames may charge the peer device without a physical contact between the peer device and the client device. In further embodiments, the one or more charging frames may include one-way energy harvesting frames. In still further embodiments, the one or more charging frames include at least one non-data bearing frame. The process 500 may transmit the one or more charging frames in burst.

Although a specific embodiment for P2P wireless charging of a peer device is described above with respect to FIG. 5, any of a variety of systems and/or processes may be utilized in accordance with embodiments of the disclosure. For example, in a variety of embodiments, the received charging association request may include a unique indicator embedded within a request packet such as a wireless frame. The indicator may be configured to distinguish the charging association request from standard association requests used in wireless networks for association. For example, the indicator may be implemented as a specific flag, tag, or a field within one or more headers of the charging association request. Upon receiving the charging association request including the indicator, the process 500 may determine that the peer device is requesting to establish a connection under a “charging” context. Thus, instead of establishing a standard two-way wireless communication session with the peer device, the process 500 may establish the one-way charging session with the peer device. The elements depicted in FIG. 5 may also be interchangeable with other elements of FIGS. 1-4 and 6-13 as required to realize a particularly desired embodiment.

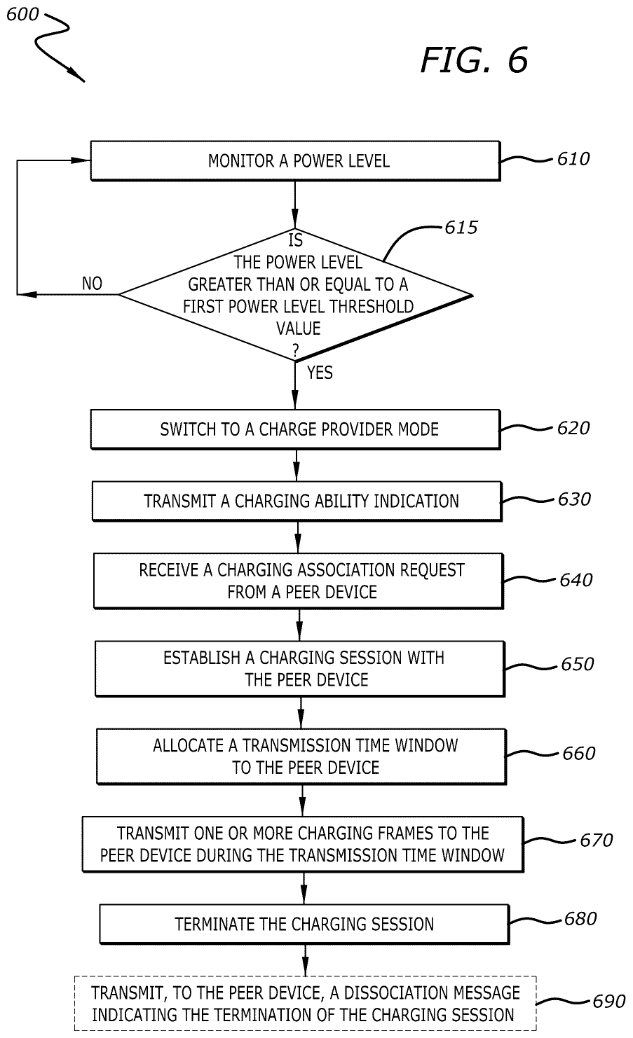

Referring to FIG. 6, a flowchart showing a process 600 for P2P wireless charging of a peer device without AP assistance in accordance with various embodiments of the disclosure is shown. The peer device may correspond to an IoT device, an AMP device, a sensor, a wearable device, or another Wi-Fi enabled device equipped with an energy harvesting circuit. Such peer devices can be depleted of charge and may need charging due to low battery. In scenarios where power sources such as outlets are unavailable, such as in mobile, remote, or emergency environments, nearby client devices (e.g., smartphones, tablets, smart hubs, servers, or the like) with sufficient power and configured with reverse charging capabilities can wirelessly charge the peer devices. The process 600 may be performed at a client device to facilitate direct wireless charging of the peer device without AP assistance.

In many embodiments, the process 600 may monitor a power level (block 610). The process 600 may monitor the power level to determine whether the client device has sufficient charge to support charging of other Wi-Fi enabled devices in its vicinity. For example, a smartphone may monitor its current power level (e.g., a 70% battery level) to determine whether the smartphone can charge an in-range peer device, such as a smartwatch with low battery. In further embodiments, the process 600 may monitor the power level of the client device by using one or more system-provided Application Programming Interfaces (APIs). These APIs may provide access to power-related information, such as a charge percentage, a charging status, and a battery health of the client device. The process 600 may register as a listener or a receiver to obtain updates regarding the power level, for example, whenever the power level changes.

In a variety of embodiments, the process 600 may determine whether the power level is greater than or equal to a first power level threshold value (block 615). The first threshold value may be indicative of a minimum power level at or beyond which the client device may be able to charge a peer device. In more embodiments, the first power level threshold value of the client device may be a configurable parameter. The setting of the first power level threshold value can be driven by various factors, including the network's energy efficiency guidelines, sustainability requirements, regulatory compliance mandates, device compatibility, a user input, or the like. In further embodiments, the process 600 may compare the power level with the first power level threshold value to determine whether the power level is greater than or equal to the first power level threshold value. In an example, the process 600 may compare the power level with the first power level threshold value based on receiving an update on the power level.

In a number of embodiments, if the power level is less than the first power level threshold value, the process 600 may continue monitoring the power level till the power level exceeds the first power level threshold value (block 610). For example, the process 600 may continue comparing the power level with the first power level threshold value at periodic intervals of time or upon receiving an update on the power level.

However, if the power level is greater than or equal to the first power level threshold value, in various embodiments, the process 600 may switch to a charge provider mode (block 620). In other words, if the client device has sufficient charge, for example, the power level is greater than or equal to the first power level threshold value, the process 600 may enable a P2P wireless charging feature on the client device by switching to the charge provider mode. Before switching to the charge provider mode, the client device may be operating in a non-charge provider mode in which the P2P wireless charging feature is disabled. Once the power level satisfies the first power level threshold value, the process 600 may cause the client device to operate in the charge provider mode, thus making the client device available to wirelessly charge in-range peer devices.

In still additional embodiments, the process 600 may transmit a charging ability indication (block 630). That is to say, once the client device is switched to the charge provider mode, the process 600 may transmit the charge ability indication. The charging ability indication may be configured to indicate at least one of a P2P charge providing capability of the client device, an amount of power the client device is capable of providing, a channel bandwidth to establish a charging session, or a signal strength threshold value required for a peer device to initiate a charging session with the client device. For example, the charging ability indication may specify whether the client device can provide P2P charging, if so at what power level (e.g., 5 watts) and over what channel bandwidth (e.g., 20 MHz). The charging ability indication may further specify the minimum signal strength or proximity level required for the peer device to initiate a charging session with the client device. This information allows nearby peer devices to determine if the client device can serve as a suitable power source. In various embodiments, the charging ability indication may be transmitted via one or more information elements in a wireless frame. In a non-limiting example, the wireless frame may be a beacon frame, a probe response frame, an action frame, a broadcast or multicast frame, an association response frame, an advertisement protocol frame, or the like. Such wireless frame can be transmitted either unsolicited or solicited. For example, the process 600 may automatically transmit (broadcast, multicast, or unicast) the wireless frame without any explicit request. In some more embodiments, the process 600 may transmit (broadcast, multicast, or unicast) the wireless frame based on an explicit request or prompt from a peer device.

In additional embodiments, the process 600 may receive a charging association request from a peer device (block 640). A peer device in need of charging may receive and analyze the charging ability indication and determine whether that the client device is a suitable power source or charge provider. Accordingly, the peer device may transmit the charging association request to request the client device for P2P charging. In yet more embodiments, the received charging association request may include a unique indicator embedded within a request packet such as a wireless frame. The indicator may be configured to distinguish the charging association request from standard association requests used in wireless networks for association. For example, the indicator may be implemented as a specific flag, tag, or a field within one or more headers of the charging association request. Upon receiving the charging association request including the indicator, the process 600 may determine that the peer device is requesting to establish a connection under a “charging” context.

In several embodiments, the process 600 may establish a charging session with the peer device (block 650). The charging session may be a one-way communication link between the client device and the peer device. The charging session may be established only if the peer device meets a specific criteria, such as signal strength, compatibility, or proximity. Once verified, the client device and the peer device may further exchange control signals or messages to confirm the initiation of the charging session. For example, prior to establishing the charging session, the client device and the peer device may execute one or more authentication and association processes. During authentication, the client device and the peer device may verify each other's identities. Once authentication is successful, the client device and the peer device may proceed with the association, where the client device and the peer device may exchange necessary parameters, such as supported features and capabilities, to establish the charging session via the stable one-way communication link from the client device to the peer device.

In further embodiments, the process 600 may allocate a transmission time window to the peer device (block 660). In other words, after or during establishing the charging session, the process 600 may allocate the transmission time window for managing network resources. Allocation of the timing window may ensure that the charging session does not interfere with other network activities of the client device. During the transmission time window, the client device may have exclusive access to the channel bandwidth for charging the peer device. The allocation of the transmission time window may also aid in conserving energy, as the client device may charge the peer device during designated times, optimizing the efficiency of the charging session.

In more embodiments, the process 600 may transmit one or more charging frames to the peer device during the transmission time window (block 670). In an example scenario, based on the charging association request, the process 600 may adjust one or more antenna parameters, such as beamforming direction, transmit power, or antenna gain, of the client device and optimize a signal transmission to the peer device. Once optimized, the process 600 may enable the client device to transmit the one or more charging frames to wirelessly charge the peer device. The one or more charging frames may be specialized packets with focused energy signals to facilitate wireless power transfer from the client device to the peer device during the transmission time window. The one or more charging frames may support wireless charging without the need for cables or direct contact. In further embodiments, the one or more charging frames may include one-way energy harvesting, non-data bearing frames. In still further embodiments, the process 600 may transmit the one or more charging frames in burst to charge the peer device.

In still more embodiments, the process 600 may terminate the charging session (block 680). The process 600 may terminate the charging session if at least one of a plurality of conditions occur. For example, the plurality of conditions may include expiration or lapse of the transmission time window, the successful completion of power transfer, the power level of the client device falling below a configured power level threshold value, or the peer device moving out of range. For example, the process 600 may terminate the charging session based on the detection that the power level of the client device is less than or equal to the configured power level threshold value. On termination, the process 600 may stop the transmission of the one or more charging frames and utilize the channel bandwidth for other network activities. The termination may further be triggered by a user input received at the client device.

In yet more embodiments, the process 600 may transmit, to the peer device, a dissociation message indicating the termination of the charging session (block 690). The dissociation message may be transmitted to formally notify the peer device that the charging session is terminated. The dissociation message may therefore help prevent miscommunication and ensure both the client device and the peer device are synchronized regarding the charging session's termination, providing a smooth transition back to standard network activities. In yet additional embodiments, the dissociation message may indicate a unique reason code (for example, “Out of capacity for charging”, “Out of range”, or the like) specifying a reason for terminating the charging session or dissociation. In many further embodiments, transmission of the dissociation message may be optional.

Although specific embodiments for P2P wireless charging of a peer device without AP assistance are described above with respect to FIG. 6, any of a variety of systems and/or processes may be utilized in accordance with embodiments of the disclosure. In a still further embodiments, the process 600 may receive a dissociation message from the peer device to terminate the charging session with the client device. For example, the peer device may be fully charged or the peer device may not be receiving sufficient signal strength from the client device, or the client device may no longer be in the vicinity of the peer device. In yet additional embodiments, the dissociation message may indicate a unique reason code (for example, “Charging no longer required”, “out of range”, or the like) specifying a reason for dissociation. The elements depicted in FIG. 6 may also be interchangeable with other elements of FIGS. 1-5 and 7-13 as required to realize a particularly desired embodiment.

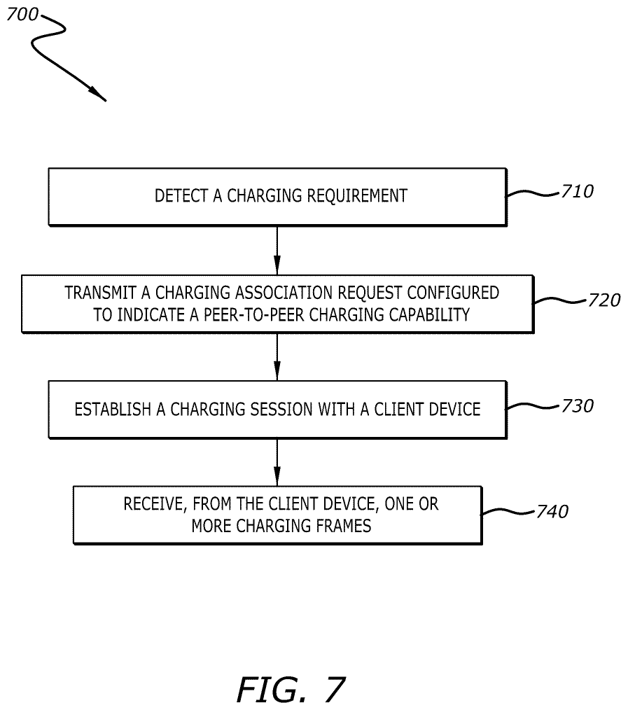

Referring to FIG. 7, a flowchart showing a process 700 for establishing a P2P wireless charging session in accordance with various embodiments of the disclosure is shown. The process 700 may be performed at a peer device (e.g., an IoT device, an AMP device, a sensor, a wearable device, or another wireless device) that may need charging. In many embodiments, the process 700 may detect a charging requirement (block 710). That is to say, the process 700 may identify that the peer device needs additional charge due to a low battery level or other power-related constraints. The process 700 may monitor a battery status, operational demands, or power consumption rate of the peer device to detect such charging requirement in the peer device. The process 700 may also consider environmental factors or specific application needs that necessitate an extended power supply. In an example scenario, the process 700 may monitor the power level of the peer device by using one or more system-provided APIs. These APIs may provide access to power-related information, such as a charge percentage, a charging status, and a battery health of the client device. The process 700 may register as a listener or a receiver to obtain updates regarding the power level, for example, whenever the power level changes. Once the need for charging is determined, the process 700 may prepare to seek assistance from nearby client devices (e.g., smartphones, tablets, servers, smart hubs, or the like) capable of P2P charging.

In a variety of embodiments, the process 700 may transmit a charging association request configured to indicate a P2P charging capability (block 720). After detecting the need for charging, the process 700 may transmit the charging association request to announce an ability of the peer device to engage in a P2P charging session. In more embodiments, the charging association request may be transmitted based on receiving one or more charging capability indications from nearby client devices. The charging capability indications may include at least one of a P2P charge providing capability of the client device, an amount of power the client device is capable of providing, a channel bandwidth to establish the charging session, or a signal strength threshold value indicating a minimum signal strength or proximity level required for the peer device to initiate a charging session with the client device. Thus, prior to transmitting the charging association request, the process 700 may analyze the one or more charging ability indications received from the nearby client devices to decide which client device the peer device may utilize as power source and transmit the charging association request. In many more embodiments, the charging association request may be broadcasted within the network or specific range to invite client devices with the P2P wireless charging capability for charging the peer device.

In a number of embodiments, the process 700 may establish a charging session with a client device (block 730). Once a client device compatible to charge the peer device responds to the charging association request, the process 700 may establish the charging session between the peer device and the client device. The process 700 may set up a secure and stable communication link between the peer device and the client device to facilitate P2P wireless charging. The charging session may ensure that both the peer device and the client device may be synchronized for an efficient power-sharing process, minimizing interference with other network activities and optimizing energy usage. In some embodiments, the charging session may be a one-way communication channel from the client device to the peer device. The charging session may be established with or without an assistance from an AP.

In still further embodiments, the process 700 may receive, from the client device, one or more charging frames (block 740). During the charging session, the process 700 may receive the one or more charging frames that carry the energy required to recharge the peer device and may include control data to maintain session stability. The process 700 may continuously monitor the one or more charging frames to ensure steady and effective power transfer, adjusting as needed to prevent overcharging or energy loss. The process 700 may continue until the power level of the peer device reaches a sufficient charge, or until the peer device decides to end the charging session.

Although a specific embodiment for establishing a P2P wireless charging session suitable for carrying out the various steps, processes, methods, and operations described herein is discussed with respect to FIG. 7, any of a variety of systems and/or processes may be utilized in accordance with embodiments of the disclosure. For example, prior to transmitting the charging association request, the process 700 may receive one or more charging ability indications from nearby client devices in a solicited manner. The elements depicted in FIG. 7 may also be interchangeable with other elements of FIGS. 1-6, and 8-13 as required to realize a particularly desired embodiment.

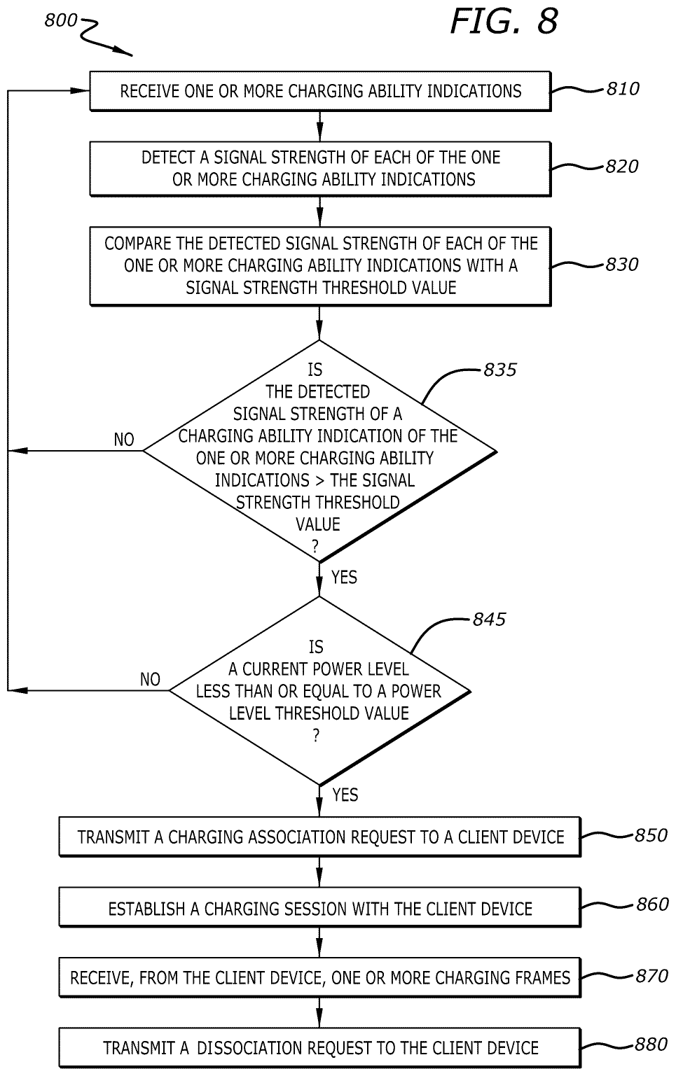

Referring to FIG. 8, a flowchart showing a process 800 for initiating a P2P contactless wireless charging session in accordance with various embodiments of the disclosure is shown. The process 800 may be performed at a peer device in need of charging. In many embodiments, the process 800 may receive one or more charging ability indications (block 810). For example, the one or more charging ability indications may include at least one of a P2P charge providing capability of a corresponding client device, an amount of power the corresponding client device is capable of providing, or a channel bandwidth to establish a charging session. The one or more charging ability indications may further indicate a signal strength threshold value (e.g., an RSSI or proximity threshold) that corresponds to a minimum signal strength or proximity level required for the peer device to initiate the charging session with the corresponding client device. The signal strength threshold value may ensure that only a client device within an optimal distance from the peer device is utilized for charging.

In a variety of embodiments, the process 800 may detect a signal strength of each of the one or more charging ability indications (block 820). In more embodiments, the process 800 may analyze the one or more charging ability indications received from one or more client devices and detect respective signal strengths. The detected signal strength may provide information about the proximity and potential charging efficiency of respective client devices associated with the one or more charging ability indications. A stronger signal strength may indicate that corresponding client device is closer to the peer device than another client device with a weaker signal strength.

In a number of embodiments, the process 800 may compare the detected signal strength of each of the one or more charging ability indications with a signal strength threshold value (block 830). For example, the signal strength threshold value may refer to a minimum required signal strength level for a client device to qualify as a charging provider for the peer device. The signal strength threshold may ensure that only the client device with sufficiently strong signals, indicating close proximity, may be selected to participate in the charging session. The process 800 may therefore determine a client device as a suitable power source by comparing the detected signal strength of each of the one or more charging ability indications with respective signal strength threshold values.

In numerous embodiments, the process 800 may determine whether the detected signal strength of a charging ability indication of the one or more charging ability indications is greater than the signal strength threshold value (block 835). If the detected signal strengths of all charging ability indications is less than respective signal strength threshold values, the process 800 may continue receiving one or more charging ability indications from one or more client devices in the vicinity of the peer device (block 810). Thus, by comparing the detected signal strength with the signal strength threshold value, the process 800 can filter out distant client devices that may lead to inefficient power transfer due to energy loss or instability.

However, if the detected signal strength of a charging ability indication of the one or more charging ability indications is greater than the signal strength threshold value, in several embodiments, the process 800 may further determine whether a current power level is less than or equal to a power level threshold value (block 845). The process 800 may monitor the power level (e.g., a battery level) of the peer device and compare the power level with the power level threshold value. The power level threshold value may be set to determine when the battery of the peer device is low enough to justify initiating a charging session with the chosen compatible client device. If the current power level falls below or equals the power level threshold value, the process 800 may proceed to seek external charging assistance from the chosen compatible client device. However, if the current power level is not below or equal to the power level threshold value, the process 800 may continue normal operation without requesting charging assistance from the chosen compatible client device (block 810).

However, if the current power level is less than or equal to the power level threshold value, in numerous embodiments, the process 800 may transmit a charging association request to the client device (block 850). The process 800 may transmit the charging association request to the client device that provided a signal strength greater than the signal threshold value. The charging association request may be a request to establish a connection under a “charging” context. For example, the charging association request may include a unique indicator embedded within a request packet such as a wireless frame. The indicator may be configured to distinguish the charging association request from standard association requests used in wireless networks for association. The indicator may be implemented as a specific flag, tag, or a field within one or more headers of the charging association request.

In additional embodiments, the process 800 may establish a charging session with the client device (block 860). After the client device accepts the charging association request, the charging session may be established between the peer device and the client device. During the charging session setup, both the peer device and the client device may agree on parameters for the power transfer, such as transmission time window and energy levels of one or more charging frames to be transmitted by the client device.

In still additional embodiments, the process 800 may receive, from the client device, one or more charging frames (block 870). The one or more charging frames may carry the necessary energy to recharge the peer device, gradually increasing the power level of the client device. The process 800 may monitor the one or more charging frames to ensure a steady and reliable power transfer. This process continues until the peer device reaches a sufficient charge level or until the charging session is otherwise terminated. In more embodiments, the one or more charging frames may be received in burst.

In further embodiments, the process 800 may transmit a dissociation message to the client device (block 880). Once the peer device is adequately charged or the charging session needs to end due to the client device being out of range, the process 800 may transmit the dissociation message to the client device. The dissociation message may signal the termination of the charging session. After receiving the dissociation message, the client device may stop transmitting the one or more charging frames, and both the client device and the peer device may resume their normal operations. In other words, the charging session terminates based on the dissociation message transmitted by the peer device.

Although a specific embodiment for initiating a P2P contactless wireless charging session suitable for carrying out the various steps, processes, methods, and operations described herein is discussed with respect to FIG. 8, any of a variety of systems and/or processes may be utilized in accordance with embodiments of the disclosure. As one of ordinary skill in the art will readily recognize, the examples and technologies provided above are simply for clarity and explanation purposes and can include many additional concepts and variations. For example, prior to receiving the one or more charging ability indications, the process 800 may transmit a charging request to an associated AP to advertise a need for charging. Based on the charging request, the peer device may be assisted by the AP to discover one or more client devices in which P2P wireless charging feature is enabled. The elements depicted in FIG. 8 may also be interchangeable with other elements of FIGS. 1-7 and 9-13 as required to realize a particularly desired embodiment.

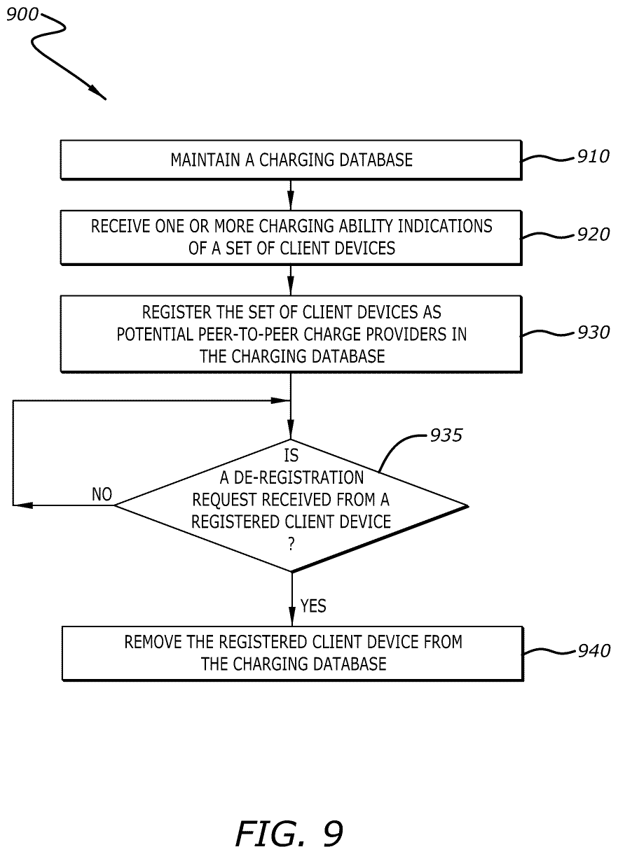

Referring to FIG. 9, a flowchart showing a process 900 for maintaining a charging database of potential charge providers in accordance with various embodiments of the disclosure is shown. The process 900 may be performed at an AP or a standalone control device communicatively coupled to the AP in a network. The AP may be communicatively coupled to a set of client devices in the vicinity of a peer device that may require charge. The set of client devices may be configured with reverse charging capabilities that may enable the set of client devices to transfer charge to the peer device in its vicinity.

In many embodiments, the process 900 may maintain a charging database (block 910). For example, the charging database may refer to an organized collection of structured information or data about various client devices that are capable of P2P wireless charging, including details such as device IDs, charging capacity, and connection status. The charging database may enable the AP to efficiently manage and coordinate wireless charging sessions between a client device and a peer device in its network. In other words, the charging database may include a list of client devices that are registered as potential P2P charge providers.

In a variety of embodiments, the process 900 may receive one or more charging ability indications of a set of client devices (block 920). A charging ability indication may indicate at least one of a P2P charge providing capability of a client device, an amount of power the client device is capable of providing, a channel bandwidth to establish the charging session, or a signal strength threshold value (e.g., an RSSI or proximity threshold) that indicates a minimum signal strength or proximity level required for a peer device to initiate a charging session with the client device. For instance, a client device may transmit a charging ability indication when a power level of the client device is greater than a first power level threshold value, for example, between 100% and 50%.

In a number of embodiments, the process 900 may register the set of client devices as potential P2P charge providers in the charging database (block 930). That is to say, upon receiving the one or more charging ability indications of the set of client devices, the process 900 may acknowledge that the set of client devices intends to participate in P2P wireless charging and thus register the set of client devices in the charging database as potential P2P charge providers. For example, the process 900 may store the charging ability indications of the set of client devices in the charging database. Thus, the charging database may include details such as a maximum power level (e.g., 5 watts) each client device of the set of client devices can supply and a channel bandwidth (e.g., 20 MHz) available to establish a stable charging session with each client device of the set of client devices. The signal strength threshold value associated with each client device of the set of client devices may ensure that peer devices within an optimal distance, where signal quality is sufficient for efficient power transfer, can connect for charging.

In numerous embodiments, the process 900 may determine whether a de-registration request is received from a registered client device (block 935). In other words, the process 900 may monitor incoming signals from the set of registered client devices. The de-registration request may be transmitted by the registered client device when the registered client device can no longer function as a charge provider, for example, due to low battery or because the registered client device is leaving the network. The process 900 may keep checking for any de-registration request received from any of the registered client devices, which would signal a change in the list of available client devices that can still act as charge providers. Accordingly, the process 900 may update the charging database. If no de-registration request is received, the process 900 may continue regular operation without altering the charging database (block 935).

However, if a de-registration request is received from a registered client device, in several embodiments, the process 900 may remove the registered client device from the charging database (block 940). The process 900 may further update the charging database to reflect a current list of available client devices as charge providers, ensuring that the removed client device is no longer solicited for energy-sharing. The process 900 may return to regular monitoring or await further registration or de-registration requests.

Although a specific embodiment for maintaining a charging database of potential charge providers suitable for carrying out the various steps, processes, methods, and operations described herein is discussed with respect to FIG. 9, any of a variety of systems and/or processes may be utilized in accordance with embodiments of the disclosure. For example, the process 900 may receive the charging ability indications or power status from client devices in a solicited manner, for example, based on a request or prompt by the AP. The elements depicted in FIG. 9 may also be interchangeable with other elements of FIGS. 1-8 and 10-13 as required to realize a particularly desired embodiment.

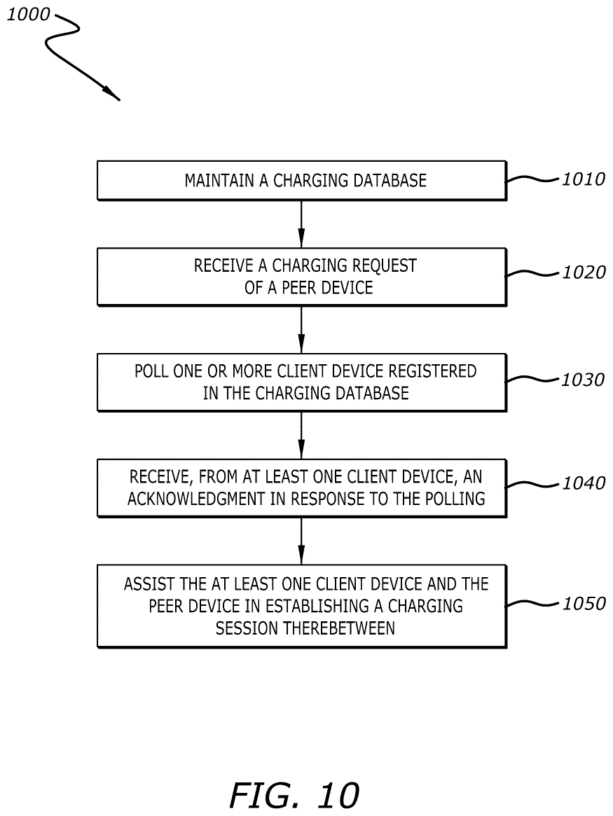

Referring to FIG. 10, a flowchart showing a process 1000 for AP assisted P2P wireless charging in accordance with various embodiments of the disclosure is shown. A plurality of client devices may be communicatively coupled to an AP in a network. A set of client devices among the plurality of client devices may be configured with reverse charging capabilities, enabling the set of client devices to transfer charge to one or more peer devices within a communication range of the set of client devices. The AP may be configured to assist in establishing a charging session between a client device of the set of client devices with a peer device in need of charge. This process 1000 may be performed at the AP or a standalone control device communicatively coupled to the AP in the network.

Accordingly, in many embodiments, the process 1000 may maintain a charging database (block 1010). For example, the charging database may refer to an organized collection of structured information or data about the set of client devices that is capable of P2P wireless charging. The charging database may include details such as device ID, charging capacity, and connection status of the set of client devices that has registered with the AP as potential P2P charge providers. In an example, the charging database may further store one or more charging ability indications of the set of client devices, indicating at least one of P2P charge providing capabilities of the set of client devices, an amount of power each of the set of client devices is capable of providing, channel bandwidths supported by the set of client devices, or signal strength threshold values (e.g., an RSSI or proximity threshold) defined by the set of client devices. In other words, the charging database may keep a track of the set of client devices that has registered as potential P2P charge providers. The charging database may further be updated based on a de-registration of a registered client device that is no longer available as a P2P charge provider.

In numerous embodiments, the process 1000 may receive a charging request of a peer device (block 1020). That is to say, the peer device in the vicinity of the AP may inform the AP that the peer device is low on power and needs to be recharged by transmitting the charging request. The charging request may be transmitted to seek the assistance of the AP in discovering client devices that can charge the peer device wirelessly using RF energy. The charging request may include information such as a required amount of power, a preferred charging method, and potentially even a signal strength threshold to help identify nearby client devices that can satisfy the charging request.

In additional embodiments, the process 1000 may poll one or more client device registered in the charging database (block 1030). The process 1000 may poll to identify a client device among the set of client devices in the charging database that is suitable for charging the peer device. In other words, the process 1000 may transmit a query to the set of client devices or a selected number of client devices that are registered in the charging database to check which client devices are currently available and willing to participate in P2P charging session with the peer device. In many further embodiments, the process 1000 may provide the charging request to the set of client devices during polling.

In still additional embodiments, the process 1000 may receive, from at least one client device, an acknowledgment in response to the polling (block 1040). The acknowledgment from a registered client device may indicate that the registered client device has received a polling request and is available to for P2P charging. In many embodiments, the process 1000 may receive acknowledgements from multiple client devices. In such a scenario, the process 1000 may determine the most suitable client device based on the one or more charging ability indications stored in the charging database and select that client device for a charging session with the peer device.

In further embodiments, the process 1000 may assist the at least one client device and the peer device in establishing a charging session (block 1050). That is to say, the process 1000 may facilitate a setup of the charging session between the at least one client device and the peer device needing power. For example, the process 1000 may enable the registered client device and the peer device to discover each other, for example, by broadcasting their presence. Then, the process 1000 may assist the registered client device and the peer device in negotiating various security settings and network parameters, for example, transmission timing, channel allocation, and power limits, to ensure efficient power transfer. The assistance for setting up the charging session allows the peer device to begin receiving one or more charging frames from the at least one client device, over a secure and stable one-way connection.

Although a specific embodiment for AP assisted P2P wireless charging suitable for carrying out the various steps, processes, methods, and operations described herein is discussed with respect to FIG. 10, any of a variety of systems and/or processes may be utilized in accordance with embodiments of the disclosure. For example, if the process 1000 receives acknowledgments from more than one registered client devices, the process 1000 may provide a list of the registered client devices that have accepted the charging request to the peer device. The peer device may then initiate a directed message to each registered client device from the received list as part of a pre-charging discovery process. Subsequently, each registered client device may transmit one or more sample charging frames to the peer device as a pre-charging response. The peer device may then evaluate received sample pre-charging frames to select the most suitable registered client device for P2P charging. The elements depicted in FIG. 10 may also be interchangeable with other elements of FIGS. 1-9 and 11-13 as required to realize a particularly desired embodiment.

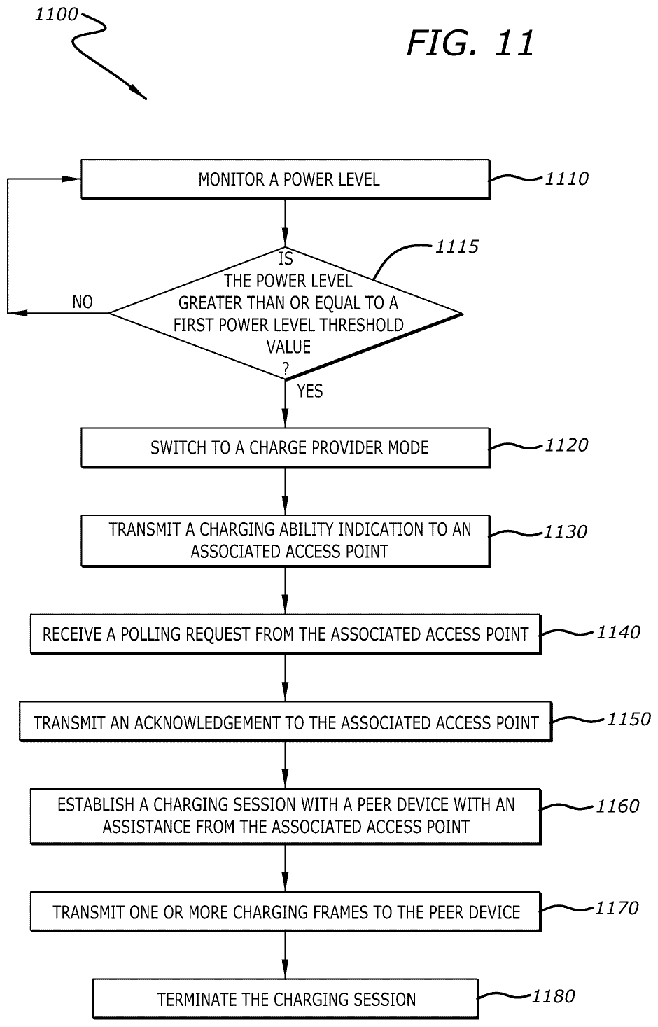

Referring to FIG. 11, a flowchart showing a process 1100 for establishing a charging session with AP assistance for P2P wireless charging in accordance with various embodiments of the disclosure is shown. The process 1100 may be performed at a client device communicatively coupled to an AP. The client device may be in a vicinity of a peer device that may require charging. The client device may be configured with P2P wireless charging capabilities, which may allow the client device to transfer charge to the peer device over a wireless connection. The AP may be configured to assist the client device in establishing a charging session with the peer device. Accordingly, in many embodiments, the process 1100 may monitor a power level (block 1110). For example, the process 1100 may continuously monitor a current power level of the client device to determine whether the client device is adequately charged. In an example scenario, the process 1100 may monitor a battery level (e.g., the power level) of the client device by using one or more APIs. These APIs may provide access to battery-related information, such as a charge percentage, a charging status, and a battery health of the client device. The process 1100 may register as a listener or a receiver to obtain updates regarding the power level, for example, whenever the power level changes.

In more embodiments, the process 1100 may determine whether the power level is greater than or equal to a first power level threshold value (block 1115). For example, the process 1100 may compare the power level with the first power level threshold value to determine whether the monitored power level is greater than or equal to the first power level threshold value. The “first power level threshold value” may refer to a minimum power level that the client device must reach or exceed to qualify as a charge provider. For example, if the first power level threshold is configured as 80%, the client device may attempt to charge another Wi-Fi enabled device if the current power level is at least 80%. If the current power level is below the first power level threshold value, the process 1100 may continue monitoring until the current power level reaches or exceeds the first power level threshold value (block 1110).

However, if the power level is greater than or equal to the first power level threshold value, in further embodiments, the process 1100 may switch to a charge provider mode (block 1120). When switched to the charge provider mode, the client device can charge a peer device through P2P wireless charging. In other words, when operating in the charge provider mode the client device can act as a charging source for the peer device.

In additional embodiments, the process 1100 may transmit a charging ability indication to the associated AP (block 1130). Upon switching to the charge provider mode, the process 1100 may announce the P2P charging capability of the client device to the associated AP by transmitting the charging ability indication. The charging ability indication may include at least one of a P2P charge providing capability of the client device, an amount of power the client device is capable of providing, a channel bandwidth to establish a charging session, a signal strength threshold value (e.g., RSSI or proximity threshold), or the like. The charging ability indication may be transmitted to the AP through a wireless frame. In more embodiments, the process 1100 may transmit the charging ability indication to the associated AP to register the client device as a potential charge provider with the AP. For example, one or more details of the client device may be included in a charging database maintained by the AP to keep a record of various charge providers.

In numerous embodiments, the process 1100 may receive a polling request from the associated AP (block 1140). The polling request may be configured to inform the registered client device regarding a peer device that needs charging. In yet more embodiments, the polling request may include various details regarding the peer device, for example, an identifier of the peer device, an amount of charge required by the peer device, a location of the peer device, or the like.

In some more embodiments, the process 1100 may transmit an acknowledgement to the associated AP (block 1150). The acknowledgment may indicate an acceptance of the client device to charge the peer device. In other words, the acknowledgment may serve as a confirmation from the client device to charge the peer device using P2P wireless charging. In an example, the acknowledgement may be a standard “ACK” signal or a more detailed message such as “ACK-Ready to initiate charging session”. Depending on a protocol supported by the client device, the acknowledgment may be transmitted in different formats. For example, the acknowledgment can include a specific bit in an information element or a bit sequence that the AP interprets as a confirmation. In further examples, the acknowledgment may include a textual acknowledgment such as a structured message.

In still more embodiments, the process 1100 may establish a charging session with a peer device with an assistance from the associated AP (block 1160). In other words, with the assistance of the AP, the process 1100 may initiate and establish the charging session with the peer device that requires charging. For example, with the assistance of the AP, the process 1100 may cause the client device to broadcast its presence to the peer device. Then, the process 1100 may assist the client device in negotiating various security settings and network parameters, for example, transmission timing, channel allocation, and power limits, to ensure efficient power transfer, with the peer device.

In still additional embodiments, the process 1100 may transmit one or more charging frames to the peer device (block 1170). In further embodiments, the one or more charging frames may include one-way energy harvesting, non-data bearing frames. The one or more charging frames may be specialized energy packets designed to facilitate wireless power transfer from the client device to the peer device. The process 1100 may transmit the one or more charging frames to the peer device during a transmission time window. In still more embodiments, prior to transmitting the one or more charging frames, the process 1100 may cause the client device to adjust one or more antenna parameters, such as beamforming direction, transmit power, or antenna gain, of the client device and optimize a signal transmission to the peer device. Further, the process 1100 may transmit the one or more charging frames to the peer device in burst.

In several embodiments, the process 1100 may terminate the charging session (block 1180). In still yet more embodiments, the process 1100 may terminate the charging session upon receiving a dissociation message from the peer device. The dissociation message may indicate a unique reason code (for example, “Out of range”, “Charging no longer required”, or the like) to specify a reason for dissociation. In additional embodiments, the process 1100 may terminate the charging session if the current power level of the client device is less than a configured threshold value. The current power level of the client device being less than the configured threshold value may indicate that the client device does not have sufficient power left to charge the peer device. The process 1100 may further transmit a dissociation message to the peer device to indicate the termination of the charging session. The termination of the charging session may stop the transmission of the one or more charging frames from the client device to the peer device.

Although a specific embodiment for establishing a charging session with AP assistance for P2P wireless charging suitable for carrying out the various steps, processes, methods, and operations described herein is discussed with respect to FIG. 11, any of a variety of systems and/or processes may be utilized in accordance with embodiments of the disclosure. For example, the process 1100 may further transmit a dissociation message to the associated AP in order to de-register the client device from the charging database managed by the AP. The elements depicted in FIG. 11 may also be interchangeable with other elements of FIGS. 1-10, 12, and 13 as required to realize a particularly desired embodiment.

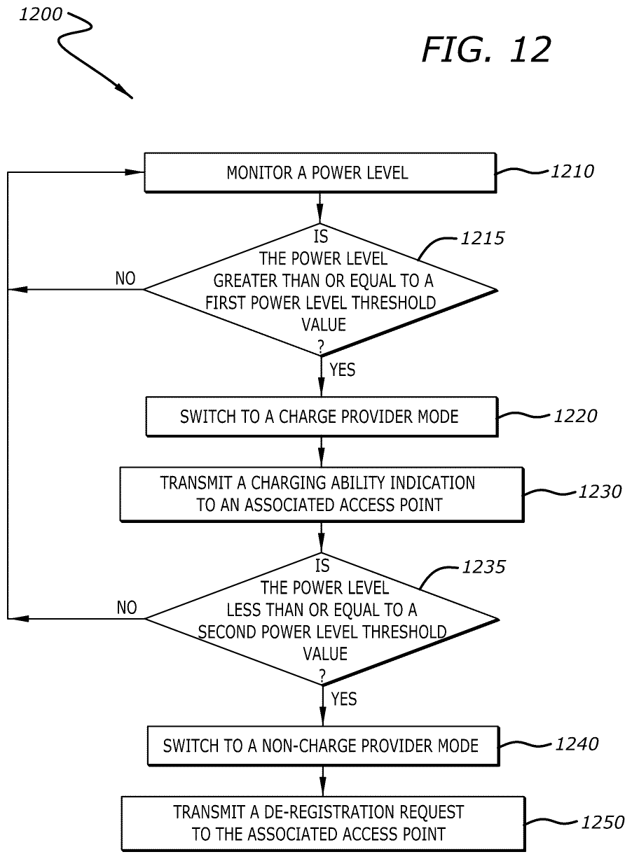

Referring to FIG. 12, a flowchart showing a process 1200 for registering/de-registering a client device as a potential P2P wireless charge provider with an AP in accordance with various embodiments of the disclosure is shown. The client device may be communicatively coupled to an AP in a network. The client device may be configured with reverse charging capabilities that may enable the client device to transfer charge to one or more peer devices over a wireless connection. The AP may be configured to assist in establishing a charging session between the client device and the one or more peer devices that need charging. This process 1200 may be performed at the client device.

Accordingly, in many embodiments, the process 1200 may monitor a power level (block 1210). The process 1200 may continuously monitor a current power level of the client device to determine if the client device can support P2P wireless charging. In an example scenario, the process 1200 may monitor a battery level (e.g., the power level) of the client device by using one or more APIs. These APIs may provide access to battery-related information of the client device. The process 1200 may register as a listener or a receiver to obtain updates regarding the power level, for example, whenever the power level changes. In further examples, the process 1200 may query a power management system of the client device to monitor the power level.

In numerous embodiments, the process 1200 may determine whether the power level is greater than or equal to a first power level threshold value (block 1215). The process 1200 may compare the monitored power level with the first power level threshold value to determine whether the power level is greater than or equal to the first power level threshold value. The first power level threshold value may refer to a minimum power the client device must have to function as a P2P wireless charge provider. In more embodiments, the first power level threshold value can be a configurable value. For example, the first power level threshold value can be configured based on a user input, an admin input, or the like. If the power level is not greater than or equal to the first power level threshold value, the process 1200 may return to the monitoring the power level (block 1210).

However, if the power level is greater than or equal to the first power level threshold value, in additional embodiments, the process 1200 may switch to a charge provider mode (block 1220). That is to say, if the power level of the client device meets the first power level threshold value, the process 1200 may control the client device to operate in the charge provider mode. For example, initially the client device may be operating in a non-charge provider mode, and when the process 1200 determines that the power level of the client device is greater than or equal to the first power level threshold value, the process 1200 may switch the client device from the non-charge provider mode to the charge provider mode. In the charge provider mode, the client device is ready to provide P2P wireless charging services to nearby peer devices that need charging. Thus, switching to the charge provider mode may involve preparing one or more internal systems and resources of the client device to execute P2P wireless charging when requested.

In still additional embodiments, the process 1200 may transmit a charging ability indication to the associated AP (block 1230). The charging ability indication transmitted to the associated AP may be transmitted to inform the AP that the client device is available for P2P wireless charging. Further, the charging ability indication may be transmitted to the AP to register the client device as a potential P2P charge provider in a charging database managed by the AP. The registration of the client device in the charging database may enable the client device to participate in a P2P wireless charging session with a peer device with assistance from AP.

In further embodiments, the process 1200 may determine whether the power level is less than or equal to a second power level threshold value (block 1235). While in the charge provider mode, the process 1200 may continue to monitor the power level and may check if the power level falls below the second power level threshold value, which is set to determine the point at which the client device should stop functioning as a charge provider. The second power level threshold value may help prevent the battery of the client device from depleting too low while charging a peer device. If the power level is still above the second power level threshold value, the process 1200 may continue operating in the charge provider mode (block 1235).

However, if the power level is less than or equal to the second power level threshold value, in still further embodiments, the process 1200 may switch to the non-charge provider mode (block 1240). The process 1200 may switch the client device to the non-charge provider mode in order to preserve remaining power of the client device for performing various functionalities associated with the client device. Switching from the charge provider mode to the non-charge provider mode may prevent the client device from charging peer devices.

In yet more embodiments, the process 1200 may transmit a de-registration request to the associated AP (block 1250). The de-registration request may be transmitted in order to inform the AP that the client device is no longer available as a charge provider. Based on the de-registration request, the client device may be removed from the charging databased as a potential charge provider. In many further embodiments, the process 1200 may transmit, to the AP, the de-registration request to remove the client device from the charging database based on the detection that the power level is less than or equal to the second power level threshold value.

Although a specific embodiment for registering/de-registering a client device as a potential P2P wireless charge provider with an AP suitable for carrying out the various steps, processes, methods, and operations described herein is discussed with respect to FIG. 12, any of a variety of systems and/or processes may be utilized in accordance with embodiments of the disclosure. For example, instead of using a local AP for coordination, a centralized cloud-based service may handle registration and management of client devices capable as acting as potential charge providers. The elements depicted in FIG. 12 may also be interchangeable with other elements of FIGS. 1-11 and 13 as required to realize a particularly desired embodiment.

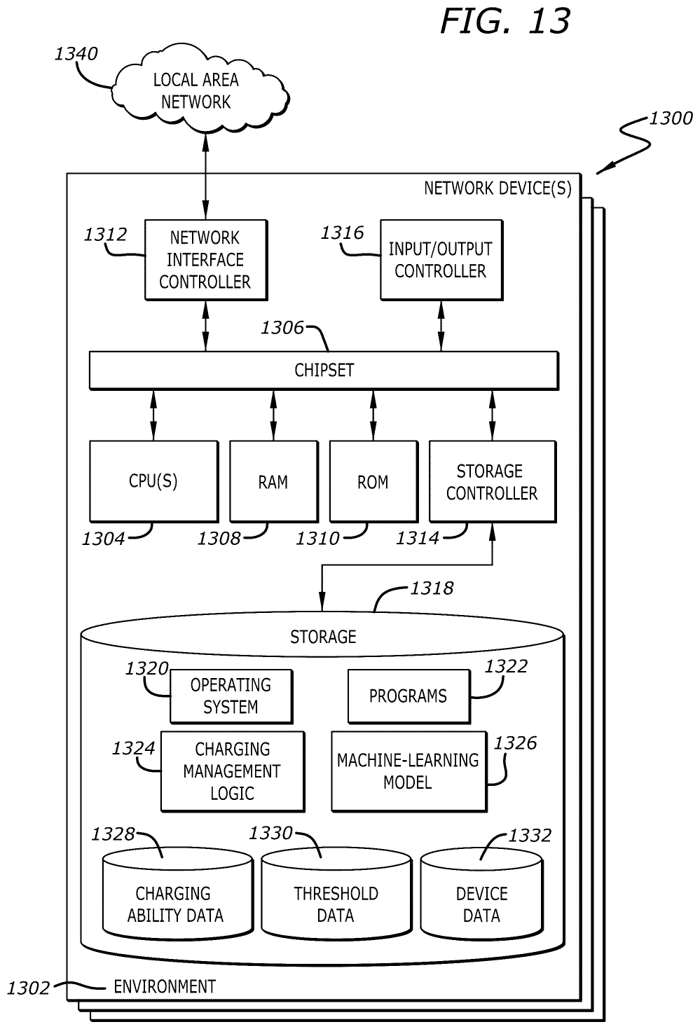

Referring to FIG. 13, a conceptual block diagram of a device 1300 suitable for configuration with a charging management logic, in accordance with various embodiments of the disclosure is shown. The embodiment of the conceptual block diagram depicted in FIG. 13 can illustrate a conventional server, computer, workstation, desktop computer, laptop, tablet, network appliance, e-reader, smartphone, or other computing device, and can be utilized to execute any of the application and/or logic components presented herein. The embodiment of the conceptual block diagram depicted in FIG. 13 can also illustrate an access point, a switch, or a router in accordance with various embodiments of the disclosure. The device 1300 may, in many nonlimiting examples, correspond to physical devices or to virtual resources described herein.

In many embodiments, the device 1300 may include an environment 1302 such as a baseboard or “motherboard,” in physical embodiments that can be configured as a printed circuit board with a multitude of components or devices connected by way of a system bus or other electrical communication paths. Conceptually, in virtualized embodiments, the environment 1302 may be a virtual environment that encompasses and executes the remaining components and resources of the device 1300. In more embodiments, one or more processors 1304, such as, but not limited to, central processing units (“CPUs”) can be configured to operate in conjunction with a chipset 1306. The processor(s) 1304 can be standard programmable CPUs that perform arithmetic and logical operations necessary for the operation of the device 1300.

In a number of embodiments, the processor(s) 1304 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 1306 may provide an interface between the processor(s) 1304 and the remainder of the components and devices within the environment 1302. The chipset 1306 can provide an interface to a random-access memory (“RAM”) 1308, which can be used as the main memory in the device 1300 in some embodiments. The chipset 1306 can further be configured to provide an interface to a computer-readable storage medium such as a read-only memory (“ROM”) 1310 or non-volatile RAM (“NVRAM”) for storing basic routines that can help with various tasks such as, but not limited to, starting up the device 1300 and/or transferring information between the various components and devices. The ROM 1310 or NVRAM can also store other application components necessary for the operation of the device 1300 in accordance with various embodiments described herein.

Additional embodiments of the device 1300 can be configured to operate in a networked environment using logical connections to remote computing devices and computer systems through a network, such as the network 1340. The chipset 1306 can include functionality for providing network connectivity through a network interface card (“NIC”) 1312, which may comprise a gigabit Ethernet adapter or similar component. The NIC 1312 can be capable of connecting the device 1300 to other devices over the network 1340. It is contemplated that multiple NICs 1312 may be present in the device 1300, connecting the device to other types of networks and remote systems.

In further embodiments, the device 1300 can be connected to a storage 1318 that provides non-volatile storage for data accessible by the device 1300. The storage 1318 can, for instance, store an operating system 1320, programs 1322, charging ability data 1328, threshold data 1330, and device data 1332 which are described in greater detail below. The storage 1318 can be connected to the environment 1302 through a storage controller 1314 connected to the chipset 1306. In certain embodiments, the storage 1318 can consist of one or more physical storage units. The storage controller 1314 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 1300 can store data within the storage 1318 by transforming the physical state of the physical storage units to reflect the information being stored. The specific transformation of physical state can depend on various factors. Examples of such factors can include, but are not limited to, the technology used to implement the physical storage units, whether the storage 1318 is characterized as primary or secondary storage, and the like.

In many more embodiments, the device 1300 can store information within the storage 1318 by issuing instructions through the storage controller 1314 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 1300 can further read or access information from the storage 1318 by detecting the physical states or characteristics of one or more particular locations within the physical storage units.

In addition to the storage 1318 described above, the device 1300 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1300. In some examples, the operations performed by a cloud computing network, and or any components included therein, may be supported by one or more devices similar to device 1300. Stated otherwise, some or all of the operations performed by the cloud computing network, and or any components included therein, may be performed by one or more devices 1300 operating in a cloud-based arrangement. By way of example, and not limitation, computer-readable storage media can include volatile and non-volatile, removable and non-removable media implemented in any method or technology.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 1318 can store an operating system 1320 utilized to control the operation of the device 1300. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 1318 can store other system or application programs and data utilized by the device 1300.

In many additional embodiments, the storage 1318 or other computer-readable storage media is encoded with computer-executable instructions which, when loaded into the device 1300, may transform it from a general-purpose computing system into a special-purpose computer capable of implementing the embodiments described herein. These computer executable instructions may be stored as programs 1322 (e.g., an application) and transform the device 1300 by specifying how the processor(s) 1304 can transition between states, as described above. In some embodiments, the device 1300 has access to computer-readable storage media storing computer executable instructions which, when executed by the device 1300, perform the various processes described above with regard to FIGS. 1-12. In certain embodiments, the device 1300 can also include computer-readable storage media having instructions stored thereupon for performing any of the other computer-implemented operations described herein.

In still further embodiments, the device 1300 can also include one or more input/output controllers 1316 for receiving and processing input from a number of input devices, such as a keyboard, a mouse, a touchpad, a touch screen, an electronic stylus, or other type of input device. Similarly, an input/output controller 1316 can be configured to provide output to a display, such as a computer monitor, a flat panel display, a digital projector, a printer, or other type of output device. Those skilled in the art will recognize that the device 1300 might not include all of the components shown in FIG. 13 and can include other components that are not explicitly shown in FIG. 13 or might utilize an architecture completely different than that shown in FIG. 13.

As described above, the device 1300 may support a virtualization layer, such as one or more virtual resources executing on the device 1300. In some examples, the virtualization layer may be supported by a hypervisor that provides one or more virtual machines running on the device 1300 to perform functions described herein. The virtualization layer may generally support a virtual resource that performs at least a portion of the techniques described herein.

In many further embodiments, the device 1300 may include a charging management logic 1324. The charging management logic 1324 can be configured to perform one or more of the various steps, processes, operations, and/or other methods that are described above. Often, the charging management logic 1324 can be a set of instructions stored within a non-volatile memory that, when executed by the processor(s) 1304 can carry out these steps, etc. In numerous embodiments, the charging management logic 1324 may perform various operations related to P2P wireless charging of peer devices. In many examples, the device 1300 may be a client device that has the charging management logic 1324. In such embodiments, the charging management logic 1324 may monitor a power level of the device 1300 to ensure whether the device 1300 has sufficient charge to transfer to other peer devices in its vicinity. The charging management logic 1324 may determine whether the power level is greater than or equal to a first power level threshold value. If the power level is greater than or equal to the first power level threshold value, the charging management logic 1324 may switch the device 1300 to a charge provider mode and may transmit a charging ability indication. The charging ability indication may be configured to indicate at least one of a P2P charge providing capability of the device 1300, an amount of power the device 1300 is capable of providing, a channel bandwidth to be utilized for establishing a charging session, or a signal strength threshold value required for a peer device to initiate a charging session with the device 1300.

In one or more embodiments, the charging management logic 1324 may further receive a charging association request from a peer device based on the transmitted charging ability indication and may establish a charging session with the peer device. The charging management logic 1324 may allocate a transmission time window to the peer device after establishing the charging session and may transmit one or more charging frames to the peer device during the transmission time window.

The charging management logic 1324 may terminate the charging session when any one of the following occurs: the charging session is complete, the battery of the peer device is sufficiently charged, the power level of the device 1300 is depleted to a configured power level threshold value, or the transmission time window has elapsed. On termination, the charging management logic 1324 may stop the transmission of the one or more charging frames and utilize the channel bandwidth for other network activities. The charging management logic 1324 may further transmit, to the peer device, a dissociation message indicating the termination of the charging session. In many further embodiments, the termination may further be triggered by a manual command from the charging management logic 1324 or a dissociation message from the peer device.

In many additional embodiments, the device 1300 may be a peer device including the charging management logic 1324. In such embodiments, the charging management logic 1324 transmit, based on a current power level of the device 1300, a charging association request configured to indicate a P2P charging capability of the device 1300. The charging management logic 1324 may establish a charging session with a client device based on the charging association request and receive, from the client device, one or more charging frames based on the established charging session. Here, the client device can be any Wi-Fi enabled device that has reverse charging capabilities, and that can perform P2P charging over wireless connection. The charging management logic 1324 may further receive a charging ability indication from the client device, detect a signal strength of the received charging ability indication, and compare the detected signal strength with a signal strength threshold value. The charging association request may be transmitted, for example, to the client device, based on the detected signal strength being greater than the signal strength threshold value.

In various embodiments, the storage 1318 can include the charging ability data 1328. The charging ability data 1328 may refer to information that the device 1300 may communicate to indicate a capability or readiness for providing a P2P wireless charging service to peer devices. The charging ability data 1328 can help an associated AP or a peer device in determining whether the device 1300 has enough power, resources, and conditions to serve as a power source for another device in need. The charging ability data 1328 may include P2P charging capability information, charging capacity, estimated available power duration, battery level percentage, charging status, available power output levels, time availability for power charging, priority level or charging availability status, temperature data, current charging role and mode, supported charging protocols or the like.

In still more embodiments, the storage 1318 can include the threshold data 1330. The threshold data 1330 in the context of charging and power-sharing systems may refer to preset limits or values that determine when a device should start or stop transmitting charging frames based on its power levels or other criteria. The threshold data 1330 may ensure that devices do not deplete their own resources while charging other devices. The threshold data 1330 may include the first threshold value may be indicative of a minimum power level at or beyond which the device 1300 may be able to wirelessly charge a nearby peer device. For example, the first power level threshold value may be a configurable parameter. The setting of the first power level threshold value can be driven by various factors, including the network's energy efficiency guidelines, sustainability requirements, regulatory compliance mandates, device compatibility, or the like. The threshold data 1330 may further include a second power level threshold which is often a lower limit, indicating when the device should stop providing charging services to conserve its own battery. For example, if the battery level drops to 20%, the device 1300 may automatically switch to a “non-charge provider mode” to avoid further depletion due to power transfer. The threshold data 1330 may further include a signal strength threshold that may dictate when a device can initiate or maintain a charging session and a temperature threshold that can affect battery performance and safety. A device may have the threshold temperature (e.g., 45° C.) above which the device 1300 may not initiate or continue charging other devices. Further, the threshold data 1330 may include a time-based threshold that may correspond to how long the device 1300 can continuously charge another device and a power drawn threshold specifying a maximum power that can be transferred to charge the other device.

In a number of embodiments, the storage 1318 can include device data 1332. The device data 1332 may refer to essential information about the device 1300 that enables efficient and safe charging interactions. The device data 1332 may include unique identifiers (such as a MAC address or device ID) to distinguish devices, battery levels or state of charge (SoC) to assess charging needs or ability, and charging ability data indicating the device's capacity to transmit or receive power.

Finally, in numerous additional embodiments, data may be processed into a format usable by a machine-learning model 1326 (e.g., feature vectors), and or other pre-processing techniques. The machine-learning (“ML”) model 1326 may be any type of ML model, such as supervised models, reinforcement models, and/or unsupervised models. The ML model 1326 may include one or more of linear regression models, logistic regression models, decision trees, Naïve Bayes models, neural networks, k-means cluster models, random forest models, and/or other types of ML models 1326.

The ML model(s) 1326 can be configured to generate inferences to make predictions or draw conclusions from data. An inference can be considered the output of a process of applying a model to new data. This can occur by learning from at least the charging ability data 1328, the threshold data 1330, and the device data 1332, and utilize the learning to predict future outcomes. For example, the ML model(s) 1326 can be used to predict a maximum amount of charge that the device 1300 can transfer to another device based on historical power usage data and historical charging data of the device 1300. Thus, if a peer device is requesting more charge than the device 1300 can transfer, the charging management logic 1324 can decline the charging association request of the peer device. To train the ML model 1326, a detailed dataset such as the charging ability data 1328, the threshold data 1330, and the device data 1332 can be gathered. Pre-processing and feature extraction may be performed to identify the most important data points. This refined data is used to train the ML model 1326, allowing it to learn relevant charging and discharging patterns of the device 1300.

Once trained, the ML model 1326 may be integrated into the device 1300 to make real-time decisions or predictions based on the power level in network devices such that the client devices always can charge a nearby peer device without transmission disruption or shutdown a data center with or without assistance from an AP. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 1326 may be generated by human/administrator verifications or may compare predicted outcomes with actual outcomes.

Although a specific embodiment for a device suitable for configuration with a charging management logic for carrying out the various steps, processes, methods, and operations described herein is discussed with respect to FIG. 13, any of a variety of systems and/or processes may be utilized in accordance with embodiments of the disclosure. For example, the device may be in a virtual environment such as a cloud-based network administration suite, or it may be distributed across a variety of network devices or switches. The elements depicted in FIG. 13 may also be interchangeable with other elements of FIGS. 1-12 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A client device, comprising:
a processor;
a memory communicatively coupled to the processor, wherein the memory comprises a charging management logic that is configured to:
transmit a charging ability indication;
receive a charging association request from a peer device based on the charging ability indication;
establish a charging session with the peer device based on the charging association request; and
transmit, based on the established charging session, one or more charging frames to the peer device.

2. The client device of claim 1, wherein the charging management logic is further configured to:
detect whether a power level of the client device is greater than or equal to a power level threshold value;
switch the client device to a charge provider mode based on the power level of the client device being greater than or equal to the power level threshold value, wherein the charging ability indication is transmitted based on the switching to the charge provider mode.

3. The client device of claim 1, wherein the charging management logic is further configured to allocate a transmission time window to the peer device based on the established charging session, and wherein the one or more charging frames are transmitted to the peer device during the transmission time window.

4. The client device of claim 1, wherein the one or more charging frames charge the peer device without a physical contact between the peer device and the client device.

5. The client device of claim 1, wherein the one or more charging frames include one-way energy harvesting frames.

6. The client device of claim 1, wherein the one or more charging frames include at least one non-data bearing frame.

7. The client device of claim 1, wherein the charging management logic is further configured to:
detect whether a power level of the client device is less than or equal to a power level threshold value; and
terminate the charging session based on the detection that the power level is less than or equal to the power level threshold value.

8. The client device of claim 7, wherein the charging management logic is further configured to transmit, to the peer device, a dissociation message indicating the termination of the charging session.

9. The client device of claim 1, wherein the charging management logic is further configured to:
receive a dissociation message from the peer device; and
terminate the charging session based on the received dissociation message.

10. The client device of claim 1, wherein the charging ability indication is configured to indicate at least one of: a peer-to-peer charge providing capability of the client device, an amount of power the client device is capable of providing, or a channel bandwidth to establish the charging session.

11. The client device of claim 1, wherein the charging ability indication is transmitted to the peer device.

12. The client device of claim 11, wherein the charging ability indication is configured to indicate a signal strength threshold value, and wherein the charging association request is received from the peer device based on a signal strength of the charging ability indication received at the peer device being greater than or equal to the signal strength threshold value.

13. The client device of claim 1, wherein the charging ability indication is transmitted to an access point to register the client device in a charging database of the access point.

14. The client device of claim 13, wherein the charging management logic is further configured to:
detect whether a power level of the client device is less than or equal to a power level threshold value; and
transmit, to the access point, a de-registration request to remove the client device from the charging database based on the detection that the power level is less than or equal to the power level threshold value.

15. The client device of claim 13, wherein the charging session between the client device and the peer device is established with an assistance from the access point.

16. A peer device, comprising:
a processor; and
a memory communicatively coupled to the processor, wherein the memory comprises a charging management logic that is configured to:
transmit, based on a current power level of the peer device, a charging association request configured to indicate a peer-to-peer charging capability of the peer device;
establish a charging session with a client device based on the charging association request; and
receive, from the client device, one or more charging frames based on the established charging session.

17. The peer device of claim 16, further comprising an energy harvesting circuit that is configured to charge the peer device based on the received one or more charging frames.

18. The peer device of claim 16, wherein the charging management logic is further configured to:
receive a charging ability indication from the client device;
detect a signal strength of the received charging ability indication; and
compare the detected signal strength with a signal strength threshold value, wherein the charging association request is transmitted further based on the detected signal strength being greater than the signal strength threshold value.

19. The peer device of claim 16, wherein the charging management logic is further configured to transmit a dissociation message to the client device based on at least one of a signal strength of the one or more charging frames being less than a signal strength threshold value or the current power level being greater than or equal to a power level threshold value, and wherein the charging session terminates based on the dissociation message.

20. A peer-to-peer wireless charging method, comprising:
transmitting a charging ability indication;
receiving a charging association request from a peer device based on the charging ability indication;
establishing a charging session with the peer device based on the charging association request; and
transmitting, based on the established charging session, one or more charging frames to the peer device.
